(19) United States
(12) Patent Application Publication
(10) Pub. No.: US 2011/0051125 A1
(43) Pub. Date: Mar. 3, 2011

(54) Apparatus and Method for Analyzing Urine Components in Toilet in Real-Time by Using Miniature ATR Infrared Spectroscopy

(75) Inventor: Dong-Soo Kim, Seongnam-si (KR)

(73) Assignee: JSM HEALTHCARE INC., Seongnam-si (KR)

(21) Appl. No.: 12/919,376

(22) PCT Filed: Feb. 26, 2009
(86) PCT No.: PCT/KR2009/000920

§ 371 Date: Oct. 27, 2010

(30) Foreign Application Priority Data
Feb. 27, 2008 (KR) 10-2008-0017910
Oct. 22, 2008 (KR) 10-2008-0103901
Feb. 25, 2009 (KR) 10-2009-0015559

(51) Int. Cl. G01N 21/00; G01J 3/00

(52) U.S. Cl. 356/51; 356/440; 250/338.1

(57) ABSTRACT

The present invention relates to a miniature apparatus for analyzing urine components and a method for real-time analyzing urine components using the same which can measure and analyze components contained in the urine in real-time.

### TECHNICAL FIELD

The present invention relates to an apparatus and a method for analyzing urine components which can measure concentrations of components contained in the urine, and more particularly, to an apparatus and a method for analyzing urine components in real-time which can measure concentrations of components contained in the urine by using an Attenuated Total Reflectance Infrared (ATR-IR) spectroscopy.

The present invention relates to an apparatus and a method for measuring and analyzing the urine in the toilet in real-time, and more particularly to develop a miniature infrared spectrometer which may be used even in special environments such as the toilet and an Attenuated Total Reflectance (ATR) which can collect a urine sample effectively and measure it reproductively, as well as attach the miniature ATR infrared spectroscopy on the toilet effectively. Further, the present invention provides an effective algorithm which can measure and analyze Glucose, Creatine, Urea, Protein, Albumine, PH, Triglyceride, Cholesterol, Bilirubin, Uric acid, and Nitrite which are urine components contained in the urine using the miniature ATR-IR attached on the toilet.

### BACKGROUND ART

Generally, methods of inspecting urine components using the visible ray have been used. The components contained in urine are analyzed using 3 wavelengths in a visible ray region, and at this time the inspection has been mainly performed by a urine test-paper. Since the method needs to use the urine test-paper which is disposable, users need to repeatedly purchase separate test-papers to measure urine components everyday. The user feels inconvenience when allowing the urine test-paper to be wet with the urine. Also, it is difficult to keep equipments including the urine test-paper in general home and thus supply it to general person.

A spectroscopy analyzing method is used as a method which does not use the urine test-paper, and at this time it is possible to analyze various components in the urine using an infrared spectroscopy. However, there is no case that the infrared spectroscopy is attached on the toilet since the infrared spectroscopy analyzing apparatus is too large to be attached on the toilet directly. Since a signal-to-noise ratio (SNR) is reduced along with miniaturizing the infrared spectroscopy, it is not possible to effectively analyze Glucose, Creatine, Urea, Protein, Albumine, PH, Triglyceride, Cholesterol, Bilirubin, Uric acid, and Nitrite which are urine components contained in a urine sample. Also, an automatic cleaner is required to be provided with the toilet since the user may not clean the sample after measuring it every time, and mixed components may not be measured effectively due to an effect of moistures in the infrared region.

As another spectroscopy method, a method of introducing the sample using a separate apparatus which introduces the sample from the toilet is used, and the apparatus is structured in a light-transmitting manner by causing an apparatus for analyzing the introduced sample, a light source and a detector to be arranged in parallel (180 degrees). The method needs an additional facility and particularly the light used in the method corresponds to near-infrared ray. A wavelength band used in the analyzing apparatus using the near-infrared ray is in a range of 800 nm to 2,500 nm. The light in the wavelength band is suitable for analyzing a single component among components contained in the urine, whereas measures for multiple components are overlapped in a case of analyzing multiple components contained in the urine, which results in difficulty in analyzing the multiple components. Consequently, there is a need for an apparatus and a method for easily and precisely analyzing multiple components contained in the urine.

Further, there is a problem in that the users or patients need to measure the urine component, a blood pressure and a body fat at different positions in different times since they do not have an apparatus for analyzing the urine components and measuring the blood pressure and the body fat by doing simple actions while sitting on the toilet.

### DISCLOSURE OF INVENTION

### Technical Problem

It is an object of the present invention to provide an apparatus and a method for receiving a urine sample and measuring it in a special environment such as a toilet by providing a miniature spectroscopy which applies mid-infrared belonging to a wavelength of 2,500 to 15,000 nm in order to realize maximum signal-to-noise ratio (SNR). Further, it is an object of the present invention to provide an apparatus and a method for analyzing urine components in real-time by providing an algorithm for measuring, analyzing and quantifying the urine components in the toilet on which the spectroscopy is attached.

Further, it is another object of the present invention to provide a health diagnostic system capable of analyzing the urine components and measuring a blood pressure and a body fat at once through simple actions.

### Technical Solution

In order to achieve the object, the present invention provides an apparatus for analyzing urine components in a toilet including a toilet stool; a urine-collector (not shown) formed on a whole surface inside the toilet stool in a concave shape or a flat shape; an analyzing unit attached on the toilet stool to analyze components of the urine collected from the urine-collector and including one or more of a light source unit, a complex filter, a reflecting minor, and a detector; and an attenuation prism(ATR prism) provided within the analyzing unit for analyzing the urine components, wherein the light source unit and a light-receiving unit of the detector have cross-sectional shape vertical to a light path corresponding similarly to each other in order to minimize a loss of the light and maintain high signal-to-noise ratio (SNR).

The light source unit used in the present invention uses a mid-infrared having wavelength in a range of 2,500 to 15,000 nm.

The analyzing unit is characterized in that a cross-sectional surface of a transmitting portion vertical to the light path corresponds similarly to a cross-sectional surface of the light source unit or the light-receiving unit of the detector.

Herein, a total trace distance until the light from the light source unit reaches the detector is about 10 to 30 mm and the total trance distance is about 1 to 50 mm if a mirror tunnel or a tapered rod is provided between the prism and the detector.

Further, a distance between the light source unit and the prism is 300 μm to 5 mm and a distance between the prism and the detector is 300 μm to 5 mm.

Meanwhile, the light source unit has an array structure in which a plurality of small heaters are arranged in one array, and the array structure of the light source unit is formed of more than 2 layers to cause pulses of the light source from the light source unit 751 and the detector to be synchronized to each other.

The light source unit according to the present invention is characterized in that it is of any one of triangular shape, round shape, or rectangular shape, and the prism and the analyzing unit correspond similarly to the light source unit.

The urine components capable of being analyzed by the urine component analyzing apparatus according to the present invention comprises any one of Glucose, Creatine, Urea, Protein, Albumin, PH, Triglyceride, Cholesterol, Bilirubin, Uric acid and Nitrite.

The analyzing apparatus according to the present invention further includes any one selected from a group consisted of a blood pressure measuring device, a body fat measuring device, and an electrocardiogram measuring device, and at this time, the analyzing apparatus may be operated after authenticating the user using a fingerprint recognition device.

The present invention provides a method for real-time analyzing urine components including: measuring a spectrum of a reference material introduced via a urine-collecting unit of a toilet using an ATR of an analyzing unit; measuring an absorption spectrum of the urine introduced via the urine-collecting unit using the ATR of the analyzing unit; acquiring a measuring line which represents the correlation between the absorption spectrum and a standard value measuring each component of the urine in advance; and estimating an amount of each component contained in the urine using the measuring line, wherein the light source unit and a light-receiving unit of the detector have cross-sectional surface vertical to a light path corresponding similarly to each other, in order to maintain high SN ratio.

The spectrum of the reference material and the absorption spectrum of the urine are measured using the mid-infrared light of a wavelength in range of 2,500 to 15,000 nm introduced into the ATR.

Preferably, the prism has a cross-sectional surface of a transmitting portion vertical to the light path corresponding similarly to a cross-sectional surface of the light source unit or the light-receiving unit of the detector.

The reference material is water, air or a combination thereof according to the urine components to be measured and the urine components includes any one of Glucose, Creatine, Urea, Protein, Albumin, PH, Triglyceride, Cholesterol, Bilirubin, Uric acid and Nitrite.

The method for analyzing the urine components further includes a step of cleaning the urine-collector using cleaning solution, and the cleaning solution and the reference material may be the same. Further, the method for analyzing the urine components further includes a step of drying the urine-collector using an air injection device formed in higher position than the urine-collector.

Further, in order to obtain the object, the present invention provides a health diagnostic system composed of a toilet bidet provided in a backside of the toilet and a fat body measuring device combined with the toilet, in which the fat body measuring device includes handles provided in leftside and rightside of the toilet; and four pairs of electrodes provided in four contact points respectively, and two of four contact points is located on a contact portion of hips or femoral region with the top portion of the toilet, and the other two contact points are positioned in the handle.

The each contact point includes a voltage electrode and a current electrode and the handle is provided in a depression type on the toilet and put on with a cover to prevent water from being wet.

The health diagnostic system further includes a urine component analyzing apparatus which measures components contained in the urine using the ATR. The ATR is directly attached on the toilet.

Further, in order to obtain the object, the present invention provides a health diagnostic system, including a toilet bidet provided in a backside of the toilet; a weight measuring device measuring a weight of user using a plurality of load cells provided under the toilet stool; and a urine component analyzing apparatus measuring components contained in the urine using the ATR, wherein the ATR is directly attached on the toilet.

The health diagnostic system further includes a blood pressure measuring device capable of measuring a blood pressure of the user; and a fingerprint recognition device capable of authenticating the user of the urine component analyzing apparatus, and the blood pressure measuring device and the fingerprint recognition device are located in the arm support member on which the user can hold his arms, and the user can perform the fingerprint recognition and the blood pressure measurement using the fingerprint recognition device and the blood pressure measuring device while sitting on the toilet.

The health diagnostic system further includes a monitor for displaying at least one of urine component information measured by the urine component analyzing apparatus, a weight information measured by the weight measuring device, a fingerprint information measured by the fingerprint recognition device, and a blood pressure information measured by the blood pressure measuring device, and a body fat information measured by the body fat measuring device, and the monitor is located in the arm support member.

The health diagnostic system further includes a medicine input device which supplies medicines used in the health diagnostic system, and the medicine input device is tilted slightly in the backside of the toilet and connected to the bidet.

The health diagnostic system transmits at least one of the urine component information, the weight information, the fingerprint information, and the blood pressure information and the body fat information via an Internet or an Ethernet.

Further, in order to obtain the objects, the present invention provides a health diagnostic system composed of a bidet provided in a backside of a toilet and an electro-cardiogram measurement device combined with the toilet, including two contact points located in left and right handles of the toilet and two contact points located in a contact portion of hips or femoral region with the top portion of the toilet, and each contact points has two electrodes respectively and the electrocardiogram measurement device records electrocardiogram of the user by flowing induced currents on eight electrodes located in four contact points to measure a potential difference between the electrodes.

### ADVANTAGEOUS EFFECTS

According to the apparatus for analyzing urine components in a toilet and the method for real-time analyzing urine components according to the present invention, there are advantages in that the apparatus may be mounted on small space of special environment such as toilet and all the urine components may be measured in real-time by allow the signal-to-noise ratio to be maintained high and a loss of light to be minimized.

Since the present invention is structured such that the light source unit, the prism and the receiving unit of the detector have cross-sectional surfaces vertical to the light path corresponding similarly to one another, it is possible to miniaturize the structure, minimize a loss of light source and increase the intensity of the light and thus sensitivity, which results in reliable spectroscopy analysis.

Further, the present invention can analyze the urine components by doing simple actions while sitting on the toilet and measure a blood pressure and a body fat conveniently so that the user can measure the urine components, the blood pressure and the body fat periodically.

### BRIEF DESCRIPTION OF DRAWINGS

FIG. 1 is a perspective view showing a health diagnostic system including a urine component analyzing apparatus according to one embodiment of the present invention.

FIGS. 2 to 4 are perspective views showing a health diagnostic system including a urine component analyzing apparatus according to another embodiment of the present invention.

FIG. 5 is a perspective view showing a body fat measuring device composing the health diagnostic system according to one embodiment of the present invention.

FIG. 6 is a perspective view showing a handle of the body fat measuring device according to one embodiment of the present invention.

FIG. 7 is a conceptual view illustrating a general infrared spectroscopy.

FIG. 8 is a conceptual view illustrating spectroscopy analysis of the urine component analyzing apparatus according to an embodiment of the present invention.

FIG. 9 is a diagram showing one embodiment of the urine component analyzing apparatus according to the present invention.

FIGS. 10 to 12 is a conceptual view of a light source unit, a prism and a light-receiving unit of a detector in an analyzing unit according to an embodiment of the present invention; (FIG. 10 is rectangular, FIG. 11 is round, and FIG. 10 is triangular.)

FIG. 13 is a perspective view illustrating that the analyzing unit according to an embodiment of the present invention is attached on the toilet.

FIG. 14 is a perspective view illustrating that an analyzing unit as a spectroscopy module according to another embodiment of the present invention is attached on the toilet.

FIG. 15 is a cut-away perspective view of a portion of the analyzing unit attached on the toilet according to an embodiment of the present invention.

FIG. 16 is an external perspective view of the spectroscopy module according to another embodiment of the present invention.

FIG. 17 is a side cross-sectional view of the spectroscopy module of FIG. 7b according to an embodiment of the present invention.

FIG. 18 is a perspective view of the analyzing unit according to an embodiment of the present invention.

FIG. 19 is a conceptual view cutting away the analyzing unit according to an embodiment of the present invention.

FIG. 20 is a conceptual view illustrating a principle of a reflecting mirror in the analyzing unit according to an embodiment of the present invention.

FIG. 21 is a conceptual view illustrating a principle of the reflecting mirror in the analyzing unit according to an embodiment of the present invention.

FIG. 22 is a conceptual view of a prism in the analyzing unit according to an embodiment of the present invention.

FIG. 23 is a conceptual view of a tapered rod and a mirror tunnel in the analyzing unit according to an embodiment of the present invention.

FIG. 24 is a display diagram displaying the light emitted on the analyzing unit according to an embodiment of the present invention.

FIG. 25 is a display diagram showing an efficiency of light amount introduced into the detector when a distance between the light source and the detector is lmmm.

FIG. 26 is a flow diagram illustrating a method for analyzing urine components according to an embodiment of the present invention.

FIG. 27 is a graph showing spectrum results obtained by measuring Glucose in the urine using the urine component analyzing apparatus according to an embodiment of the present invention.

FIG. 28 is a graph showing spectrum results obtained by measuring Creatine in the urine using the urine component analyzing apparatus according to an embodiment of the present invention.

FIG. 29 is a graph showing spectrum results obtained by measuring Urea in the urine using the urine component analyzing apparatus according to an embodiment of the present invention.

FIG. 30 is a graph showing spectrum results obtained by measuring Cholesterol in the urine using the urine component analyzing apparatus according to an embodiment of the present invention.

FIG. 31 is a graph showing spectrum results obtained by measuring Bilirubin in the urine using the urine component analyzing apparatus according to an embodiment of the present invention.

FIG. 32 is a graph showing spectrum results obtained by measuring Uric acid in the urine using the urine component analyzing apparatus according to an embodiment of the present invention.

FIG. 33 is a graph showing spectrum results obtained by measuring Nitrite in the urine using the urine component analyzing apparatus according to an embodiment of the present invention.

FIG. 34 is a resulting graph showing a measuring line of Glucose in the urine using the urine component analyzing apparatus according to an embodiment of the present invention.

FIG. 35 is a resulting graph showing a measuring line of Creatine in the urine using the urine component analyzing apparatus according to an embodiment of the present invention.

FIG. 36 is a resulting graph showing a measuring line of Urea in the urine using the urine component analyzing apparatus according to an embodiment of the present invention.

FIG. 37 is a resulting graph showing a measuring line of Cholesterol in the urine using the urine component analyzing apparatus according to an embodiment of the present invention.

FIG. 38 is a resulting graph showing a measuring line of Bilirubin in the urine using the urine component analyzing apparatus according to an embodiment of the present invention.

FIG. 39 is a graph for measuring Uric acid contained in the urine sample using the urine component analyzing apparatus according to an embodiment of the present invention.

FIG. 40 is a graph for measuring Urea contained in the urine sample using the urine component analyzing apparatus according to an embodiment of the present invention.

FIG. 41 is a spectrum for standard Glucose according to Fourier Transform Infrared (FT-IR).

FIG. 42 is a spectrum for standard Glucose according to LFV IR.

FIG. 43 is a spectrum for urine sample according to FT IR.

FIG. 44 is a spectrum for urine sample according to linear variable filter infrared (LVF IR).

### DETAILED DESCRIPTION OF MAIN ELEMENTS

1000: leg-support member
100: blood pressure measuring apparatus
200: bidet control apparatus
300: fingerprint recognition apparatus
400: monitor
500: main control apparatus
600: body fat measuring apparatus
601˜608: electrodes
609: handle
610: slit
611: Cover
700: urine component analyzing apparatus
710: toilet
720: air injection device
750: analyzing unit
751: light source unit
752: reflecting mirror
753: prism
754: light inductor
755: detector
756: controller
757: light incident into the ATR prism
758: sample
759: mirror tunnel
760: spectroscopy module
761: linear variable filter
762: light-receiving unit
800: medicine input apparatus
900: weight measuring apparatus

### BEST MODE FOR CARRYING OUT THE INVENTION

Practical and presently preferred embodiments of the present invention are illustrative as shown in the following Examples and Comparative Examples.

However, it will be appreciated that those skilled in the art, on consideration of this disclosure, may make modifications and improvements within the spirit and scope of the present invention.

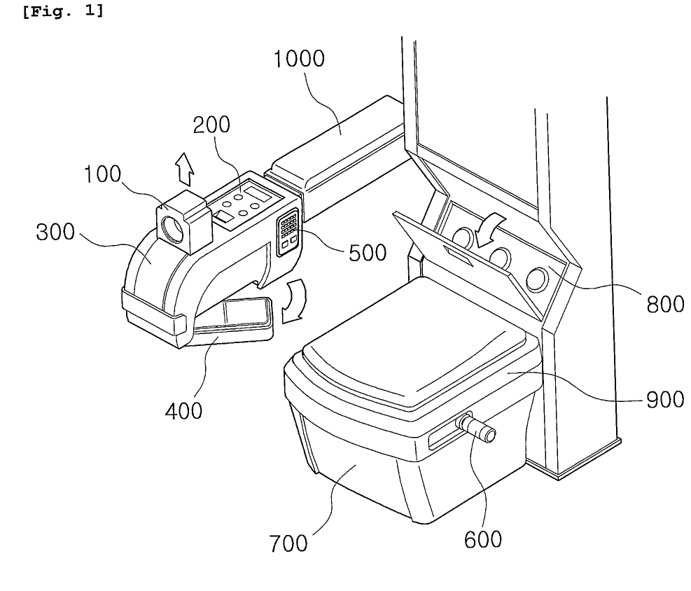

FIG. 1 is a perspective view showing a health diagnostic system including a urine component analyzing apparatus 700 according to one embodiment of the present invention. Referring to FIG. 1, the health diagnostic system includes a blood pressure measuring apparatus 100, a bidet control apparatus 200, a fingerprint recognition apparatus 300, a monitor 400, a main control apparatus 500, a body fat measuring apparatus 600, a urine component analyzing apparatus 700, a medicine input apparatus 800 and a weight measuring apparatus 900.

In FIG. 1, even though it is shown that the blood pressure measuring apparatus 100 is rectangular-shaped or open cuff-shaped and is positioned on a top surface of a leg-support member 1000, the present invention is not limited to the shape and the position of the blood pressure measuring apparatus 100.

Further, the health diagnostic system measures a weight using the weight measuring apparatus 900 and measures a body fat using the body fat measuring apparatus 600.

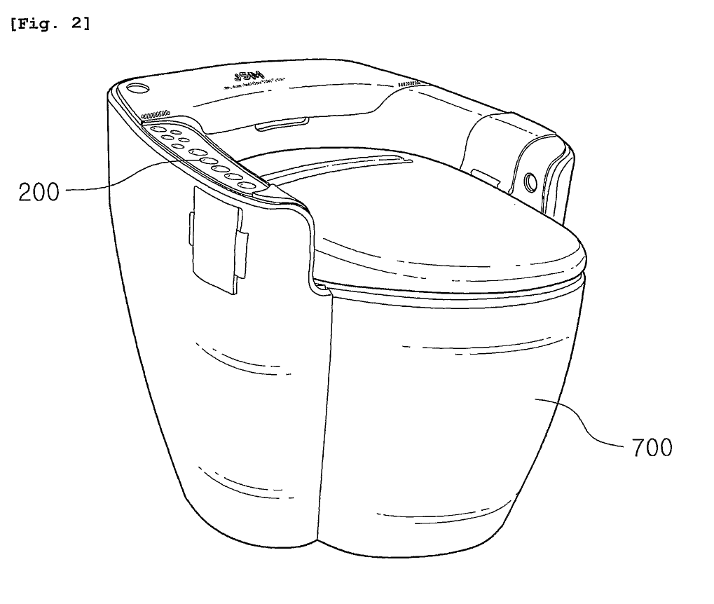

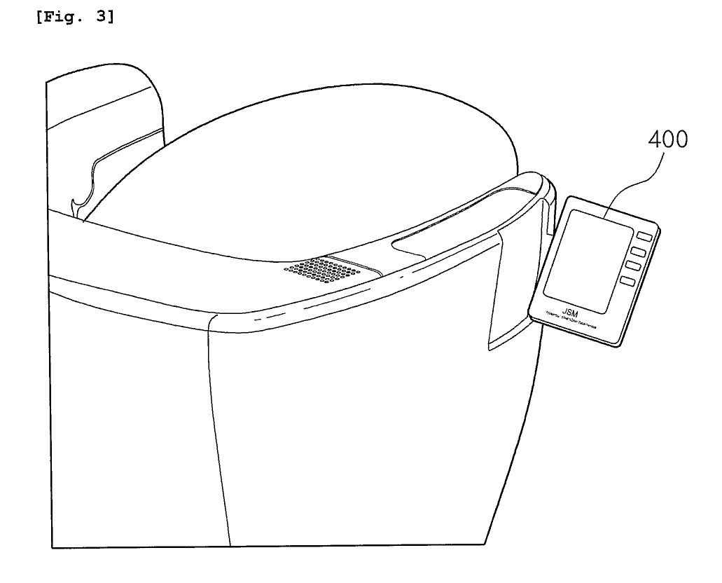

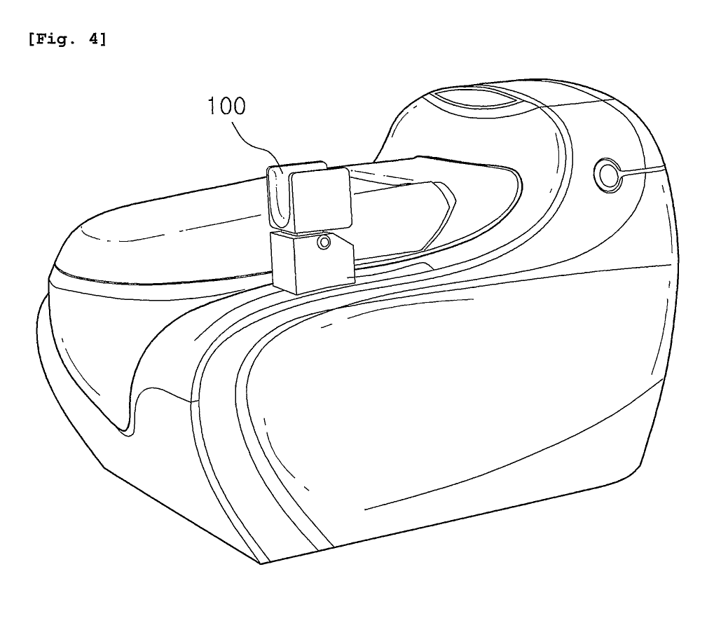

Meanwhile, FIGS. 2 to 4 show external perspective views showing the health diagnostic system of various models including the urine component analyzing apparatus 700 according to still another embodiment of the present invention.

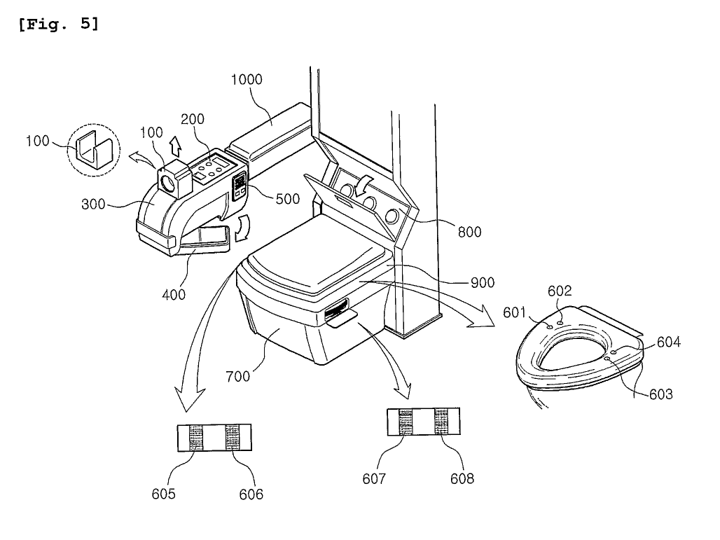

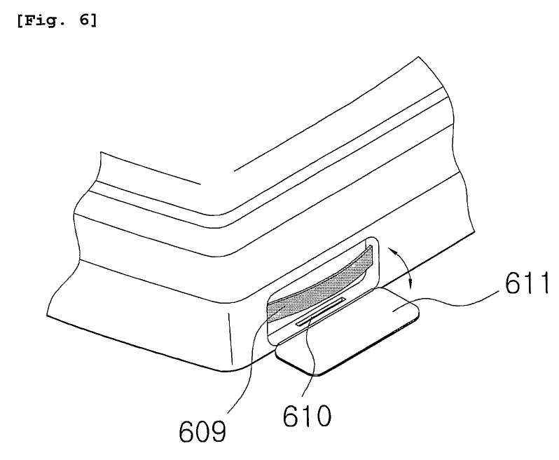

The body fat measurement is to be initiated once a user grasps a handle 609 of the body fat measuring apparatus 600 having electrodes 601 to 608 embedded in left and right sides on a top portion of the toilet 710 after sitting on the toilet 710. Hereinafter, the body fat measuring apparatus 600 will be specifically described referring to FIGS. 5 and 6.

A method for measuring the body fat will be described specifically. Once a button of a “body fat measurement” is pressurized, the pressure sensor of the weight measuring apparatus 900 is operated to measure the weight. Then, the user pressurizes a button of “start” and extends both legs down while sitting on the toilet 710 to grasp the handle 609 of the fat body measuring apparatus 600. When the fat body measurement is completed, corresponding information such as a body fat percentage and an amount of muscles are displayed on a monitor 400 using an age, a sex distinction and a height of the user which are saved in advance and the weight measured by the weight measuring apparatus 900. If the weight information is already acquired, the weight measurement procedure may be omitted.

The monitor 400 may be projected in such a manner that it is rotated in horizontal direction about one axis held from bottom surface of the leg-support member 1000.

Further, the health diagnostic system measures sugar, protein and blood contained in the urine using the urine component analyzing apparatus 700 to display them on the monitor 400. The specific description of the urine component analyzing apparatus 700 will be specifically described referring to FIG. 2 to FIG. 6.

Further, the health diagnostic system includes the medicine input device 800 positioned on the backside of the urine component analyzing apparatus 700. A medicine such as cleaning agent and aromatic may be input through the medicine input device 800. The medicine input device 800 may be structured such that it is allowed to be correctly combined with the medicine case and tilted slightly to cause the medicine to be dropped down easily. Therefore, the medicine case may be inserted into the medicine input device 800 and then removed from the medicine input device 800 when all of the medicine is consumed. The medicine input device 800 is connected to the bidet device and the medicine input to the medicine input device 800 is sprayed via the bidet device.

FIG. 5 shows the body fat measuring device 600 composing the health diagnostic system according to one embodiment of the present invention. Referring to FIG. 5, the body fat measuring device 600 has four electrodes 601, 602, 603, 604 provided on a toilet seat of the toilet 710 and two electrodes 605, 606, 607, 608 provided on both handle 609 respectively, so that the body fat may be measured using total eight electrodes 601, 602, 603, 604, 605, 606, 607, 608.

In other words, a voltage electrode and a current electrode are provided on each handle 609 of left side and right side of the toilet 710, and additional four electrodes (two voltage electrodes and two current electrodes) are provided on a contact portion of hips or femoral region with the top portion of the toilet 710, in which two electrodes (voltage electrode and current electrode) compose one contact point.

FIG. 6 shows the handle 609 of the body fat measuring device 600 according to one embodiment of the present invention. Referring to FIG. 6, the handle 609 of depression type may be provided on both sides of the toilet 710 and put on with a cover 611 to prevent water from being wet. Further, the cover 611 may be provided with a slit 610 on its lower side so that the water entering into outer surrounding grooves may leak out.

FIG. 7 shows a Fourier Transform infrared spectroscopy used in general laboratory. Referring to FIG. 7, the infrared spectroscopy is divided into a light source unit 741, a beam splitter 742, a first reflecting mirror 743, a monochromator (not shown), a sample measuring unit 744, a second reflecting mirror 745 and a detector 746.

In a case of using prior infrared spectroscopy shown in FIG. 7, since its size reaches 20 to 50 cm and its weight reaches 10 kg, it is difficult to apply it to small space such as the toilet 710 according to an embodiment of the present invention.

Generally, as the light generated from the infrared light source unit is far away from the light source, it is dramatically decreased proportionally to an inverse of the square of the distance. In prior large Fourier Transform Infrared (FT-IR) spectroscopy, it needs to perform complex procedures such as using the light source of high output and adjusting the frequency via a chopper to prevent diffusion of the light and background noise or using a monochromator or an interperometer additionally, in order to achieve high signal-to-noise ratio. However, in the toilet 710, it is not possible to use the chopper, the monochoromter or the interperometer since the analyzing unit 750 needs to be provided in the small space. Therefore, when the heat-generating area of a single-structured radiating plate of the light source unit is attempted to be increased for the purpose of obtaining adequate light from the small light source, the response time is increased and therefore it is impossible to be detected at the detector. Further, there is a problem that it is difficult to transmit adequate light to the ATR when reducing the output of the light source to reduce the size of the radiating plate. Even though there is an attempt to use the infrared spectroscopy to analyze the urine components, suitable and reliable results may not be obtained in a range of mid-infrared ray.

In order to address such problems, the present inventors contemplate a scheme which can increase the signal-to-noise ratio while miniaturizing the analyzing apparatus, i.e., synchronize pulse frequency of the light source to one of the detector 755 while decreasing a loss of the light amount and increasing an intensity of the light, upon mounting the analyzing apparatus on small space such as the toilet 710. Such adequate design scheme includes a technology which takes a line sensor in a light-receiving unit 762 of the detector 755 capable of receiving a desired spectrum. Herein, the frequency synchronization technology includes a technology which controls the frequency synchronization of signals from the light source and the detector 755 sensor by a Central Processing Unit (CPU).

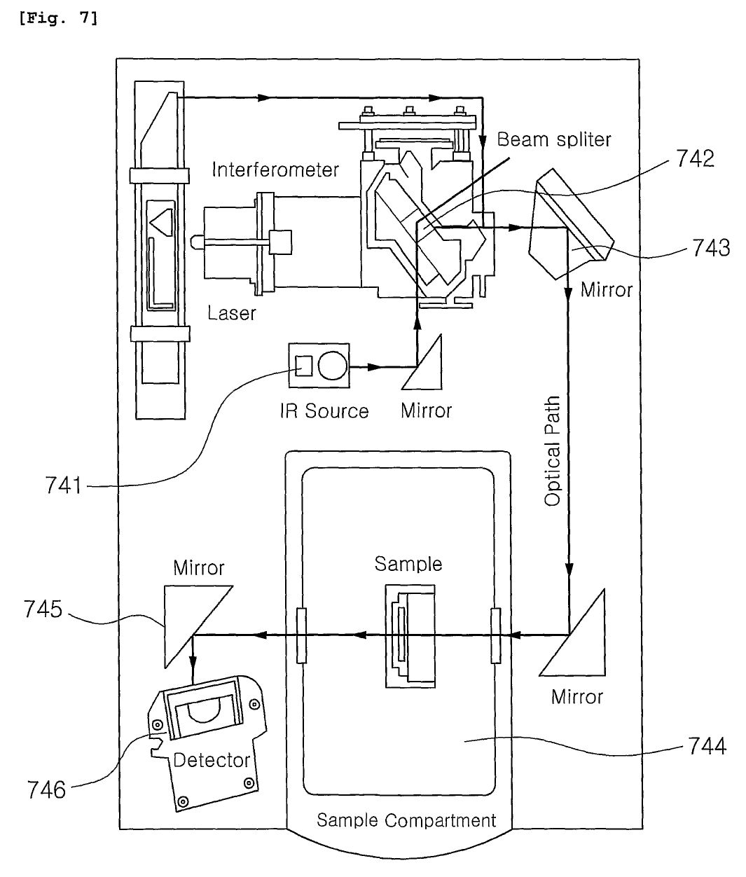

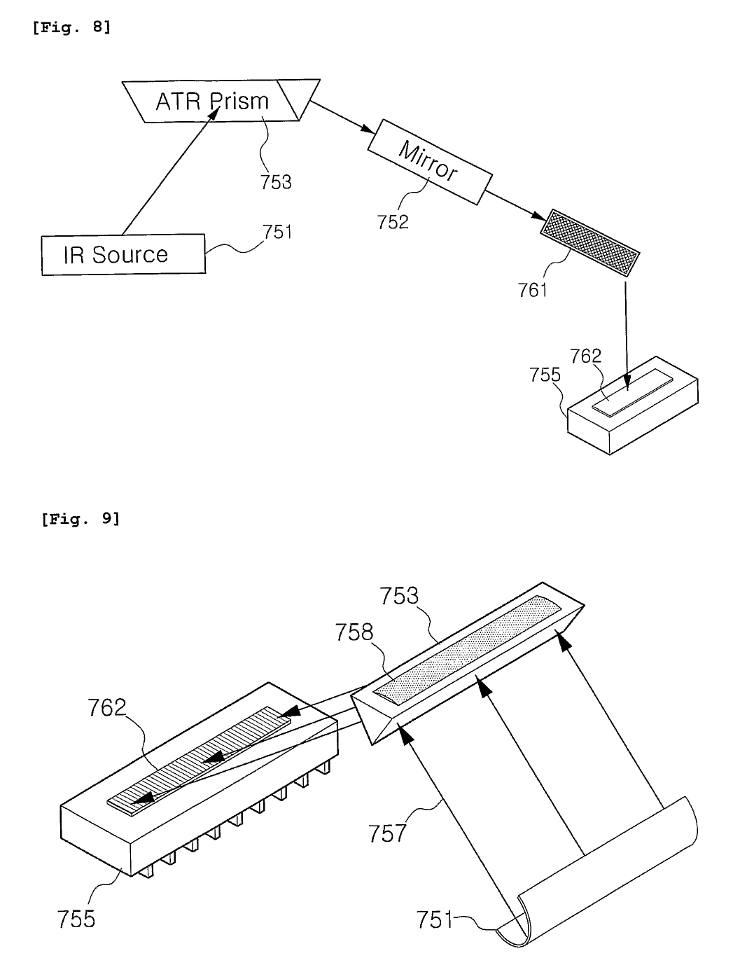

FIG. 8 is a conceptual view which explains internal spectroscopy analyzing principle of the analyzing apparatus according to an embodiment of the present invention. According to the present invention, surface shapes of the light source unit 751, the ATR, the filter 761 and the light-receiving unit 762 (line sensor) of the detector 755 are made to correspond similarly to one another, for the purpose of miniaturizing the analyzing apparatus and minimizing a loss of the light. In other words, if the corresponding surface of the light source unit 751 is of rectangular shape having large aspect ratio, ATR prism 753, mirror or tapered rod, a linear variable filter 761 (LVF), and the light-receiving unit 762 (line sensor) of the detector 755 through which the generated light is transmitted are also of rectangular shape.

The analyzing apparatus according to the present invention maximizes the signal-to-noise ratio and increases the intensity of the light generated from the light source unit 751 while preventing nonconformity of the pulse wavelength without delay of response time at the detector 755. For the purpose of it, the analyzing apparatus has materials, polishing feature, arrangement degree and distance between the components which are determined to cause each component to exhibit optimum performance.

FIG. 9 shows one embodiment of the analyzing apparatus according to the present invention. The light source unit 751 of the analyzing apparatus has a length of 13 to 14 mm and a width of 3 to 4 mm, the ATR prism 753 has a length of 13 to 14 mm and a width of 3 to 4 mm, and the light-receiving unit 762 (line sensor) of the detector 755 has a length and a with of 12 mm and 2 mm, respectively.

The concept of such embodiment is such that a shape of sensor in the detector 755 corresponds similarly to shapes of the light source unit 751 and the prism 753 in order to minimize a loss of the light in hardware.

The distance between the light source unit 751 and the prism 753 is in a range of 300 μm to 5 mm and the distance between the prism 753 and the detector 755 is in a range of 300 μm to 5 mm. A total trace until the light generated from the light source unit 751 reaches the detector 755 through the prism 753 is in a range of about 10 to 30 mm. However, when a mirror tunnel 759 or taper rod is provided between the prism 753 and the detector 755, the total trace is preferably in a range of about 10 to 50 mm. Generally, since the intensity of the light is decreased proportionally to an inverse of the square of the distance of the light source and the light is spread over surrounding region, the analyzing apparatus according to the present invention preferably is such that a light path should be kept as short as possible.

The design concept of keeping the distance between each component within a prescribed range is to prevent the intensity of the light from being attenuated proportionally to the square of the propagating distance and ultimately to optimize the SN ratio for the purpose of minimizing a loss of the light.

The present invention makes it possible to miniaturize the analyzing apparatus and to attach it on small space such as the toilet 710, by making the distance between the components or total traces of the light source very short without a need for providing a separate driving equipment which is necessary for the existing large FT-IR equipment.

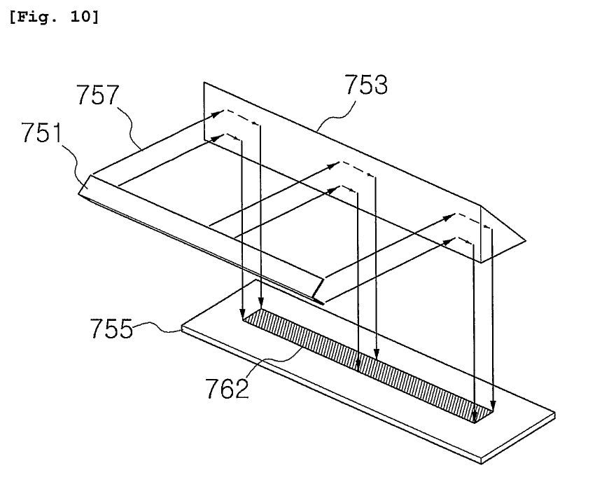

FIG. 10 shows main components of the analyzing unit 750 according to an embodiment of the present invention. The analyzing unit 750 according to the present invention is structured such that cross-sectional shapes vertical to the light path at the light source unit 751, the prism 753 the light-receiving unit 762 (line sensor) of the detector 755 may correspond similarly to one another in order to keep the loss of light low and the SN rate high.

In FIG. 10 shows that the light source unit 751 is of rectangular shape and also the light source generated from the light source unit 751 is incident into the prism 753 with the cross-sectional surface of rectangular shape in advance direction, and the prism 753 is of rectangular shape similar to the cross-section surface of the light source unit 751 not to cause a loss of the incident light source. After the light source is incident into the prism 753 and refracted, the reflected light source is of rectangular shape having cross-section surface vertical to the advance direction and finally entered into the detector 755. The light-receiving unit 762 of the detector 755 is also of rectangular shape not to cause a loss of the light source. Due to such structure, since the light source generated from the light source unit 751 can reach the light-receiving unit 762 via the prism 753 without a loss, it may be used in the miniature analyzing apparatus efficiently.

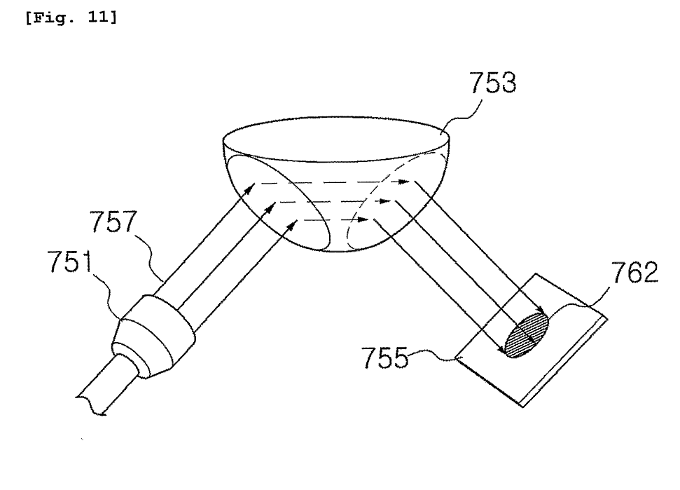

In FIG. 11 is a conceptional view according to another embodiment showing that a combination of the light source unit 751, the prism 753, and the light-receiving unit 762 of the detector 755 makes a round shape. In FIG. 12 is a conceptual view according to still another embodiment showing a combination of the light source unit 751, the prism 753 and the light-receiving unit 762 of the detector 755 makes a triangle shape. At this time, the prism 753 may be of any shape if it has an incidence plane and an emittance plane opposite to each other with a prescribed degree. For example, it may be a triangular prism 753 shape. Further, whatever the light source unit 751, the prism 753 and the light-receiving unit 762 of the detector 755 correspond similarly to one another belong to a scope of the present invention.

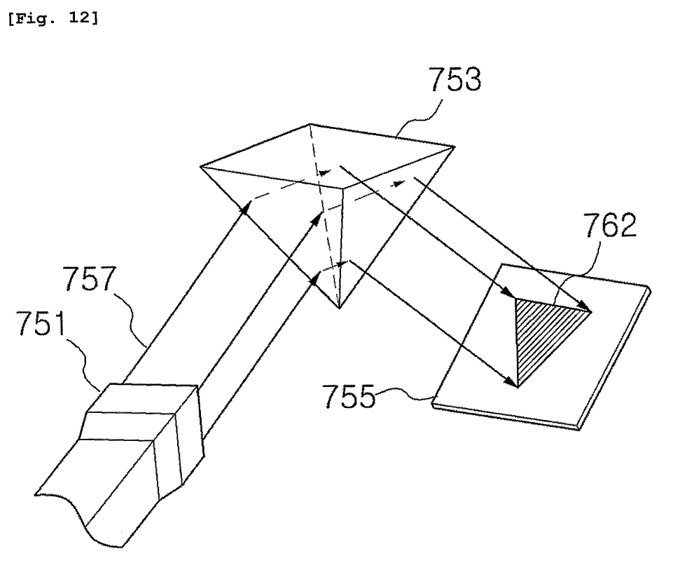

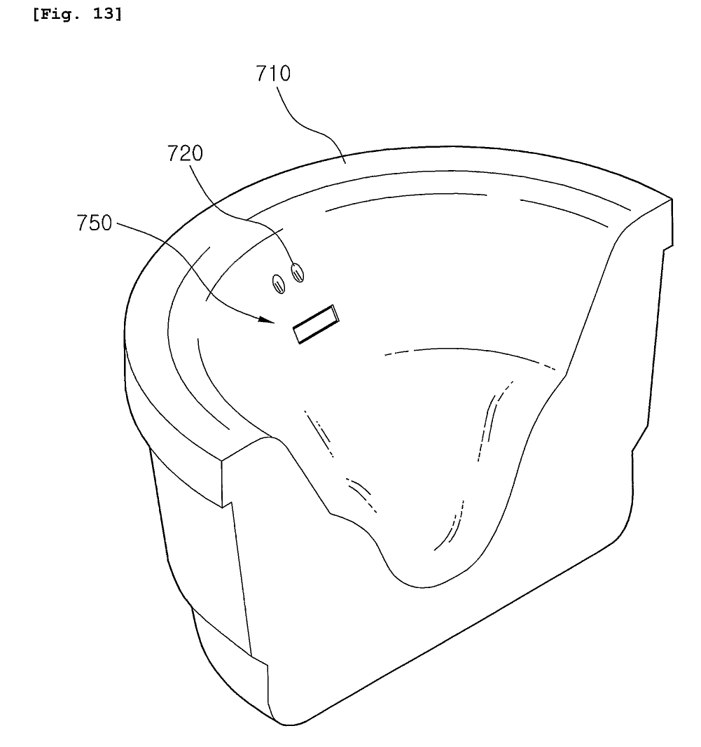

FIG. 13 and FIG. 14 are perspective views showing the analyzing unit 750 of the urine component analyzing apparatus 700 according to an embodiment of the present invention. Referring to drawings including FIG. 13 and FIG. 14, the analyzing unit 750 includes a light source unit 751, a reflecting mirror 752, a prism 753, a light inductor 754, a detector 755, and a controller 756. In the analyzing unit 750 according to the embodiment, the ATR is composed of the prism 753 and the light inductor 754. The analyzing unit 750 according to the embodiment is miniaturized to allow it to be used as a sensor for measuring urine, and simultaneously is structured to increase the signal-to-noise ratio.

FIG. 13 and FIG. 14 show one embodiment of the present invention, in which the light source unit 751 may be of multi-array structure by arranging a plurality of small light sources of low power in one array or multiple arrays to increase a life-time of the light source unit 751 while increasing the signal-to-noise ratio. Though spectroscopy analysis may use a method for increasing the intensity of the light source by using a halogen lamp or increasing a size of the radiating plate, there is a problem that a response time at the detector 755 is delayed so that it may not perform correct sensing since the single radiating plate is big-sized. In order to address the problem, the light source unit 751 according to the present invention forms a linear light source unit 751 of array shape by arranging a plurality of radiating units having small heat-generating area in one array. In other words, it is possible to overcome the problem with the response time being delayed at the detector 755 by arranging 10 or more small radiating units of 1 mm×1 mm or 5 or more small radiating units of 1.5 mm×1.5 mm in one array.

That is, by making a size of each radiating unit in the plurality of small radiating units (light source unit 751) smaller as compared with prior art, it is possible to improve a modulation depth without a problem in light-radiating function even though on/off are performed several tens times per a second and to controllably synchronize light signals (pulse) of the light source unit 751 and the detector 755 by a CPU controller 756 in a software. The structural durability may be improved by using platinum as a material of the light source unit 751 even though on/off are performed several tens times per a second, which results in overcoming the problem with the light-radiating capability being decreased.

Further, the array structure of the light source unit 751 may be consisted of two arrays so that the pulse from the light source unit 751 may synchronize to one from the detector 755. This is for the purpose of keeping intensity of the light source high and synchronizing the signal wavelength of the light source reaching the light-receiving unit 762 of the detector 755.

The analyzing unit 750 of the present invention may not use the chopper due to a structural characteristic that it is attached on small space such as the toilet 710. Instead, the light source unit 751 uses multiple light sources of low output and linear multi-array light lay. For the purpose of miniaturizing the analyzing apparatus, a linear variable filter 761 (LVF) is provided at a front end of the detector 755. The linear variable filter 761 is produced via Micro-Electro-Mechanical Systems (MEMS) technology.

The ATR is one method for obtaining the infrared spectrum of the sample 758 which is difficult to be treated in general absorption spectroscopy, which is an analysis method or an analysis apparatus used to measure solid, film, fiber, paste and adhesive and/or powder sample 758 of low solubility.

When the light passes from dense medium to coarse medium, the reflection occurs typically. At this time, the reflection rate of the incident light is increased when the incidence degree is increased, and total reflection takes place when it excesses any threshold degree.

When such reflection takes place, it is known experimentally and theoretically that the light acts like penetrating into the coarse medium by a small distance. At this time, penetrating depth of the light is varied in a range of several tenths wavelengths to several wavelengths. Specifically, when causing the urine sample 758 to wet a surface of the ATR exposed to the toilet 710, the light is passed to the sample 758 via the ATR.

As mentioned earlier, the ATR machine may be properly used to measure the solid, film, fiber, paste and adhesive and/or powder sample 758 of low solvability and to analyze the solution due to advance of materials resistant to water solution such as diamond or ZnSe. Typically the reflection takes places when the light passes from the dense medium to the coarse medium, and at this time, the reflection rate of the incident light is increased if the incidence angle is increased and total reflection takes place if it exceeds any threshold degree. When such reflection takes places, it is known experimentally and theoretically that the light acts like penetrating into the coarse medium by a small distance. At this time, penetrating depth of the light is varied in a range of several tenths wavelengths to several wavelengths.

The final penetration depth depends on a wavelength of the incident light, refractive index of two materials and the incidence degree to interface surface. The penetrating radiant light is referred to an evanescent wave. The light of absorption band wavelength is attenuated when the coarse medium absorbs the evanescent wave. The light passing the prism 753 is introduced into the detector 755 through the LVF (not shown) via an optimum optical system by the light inductor 754 such as a tapered rod. The light detected by the detector 755 is converted into the digital signal by the controller 756 to be measured. The controller 756 measures the data detected and controls each portion electronically.

FIG. 14 is a perspective view showing that a spectroscopy module 760 is attached to the toilet 710.

FIG. 15 is a cross-section view showing that the light passes the analyzing unit 750 of the urine component analyzing apparatus 700. Referring to FIG. 15, the light generated at the light source unit 751 is reflected at the reflecting mirror 752 surrounding the light source unit 751 and incident into the ATR prism 753. An interior of the reflecting mirror 752 is formed in a parabola shape, and the light source unit 751 is located in a focus portion of the parabola so that the light generated by the light source unit 751 is reflected on the reflecting mirror 752 and incident into the ATR prism 753 as a parallel light. Even though the reflecting mirror 752 of parabolic shape is shown in FIG. 15, the present invention is not limited to it.

The light 757 incident into the ATR prism 753 is totally reflected after a portion of the wavelength is absorbed by the sample 758 at an inclined plane of the ATR prism 753 and introduced into the detector 755 through the light inductor 754 (tapered rod). The detector 755 senses the intensity of the light introduced. The analyzing unit 750 according to the present invention can increase the total intensity of the light greater than when using one light source of high output by using several light sources of low output and overcome a problem of the intensity of the light being dramatically reduced by using the parallel light.

Though not shown specifically, the analyzing unit 750 is depressed downwardly on a basis of an internal side of the toilet 710 when the analyzing apparatus 750 is attached on the toilet 710, because the urine may be analyzed only when a prescribed amount of it is on the prism 753.

The analyzing unit 750 may be primarily cleaned using cleaning solution of the toilet 710 after excretion and secondly cleaned using an air injection device 720 which is separately provided at the toilet 710. The air injection device 720 is preferably mounted within the toilet 710 and provided at a degree suitable to cause the air to be injected to the analyzing unit 750 correctly.

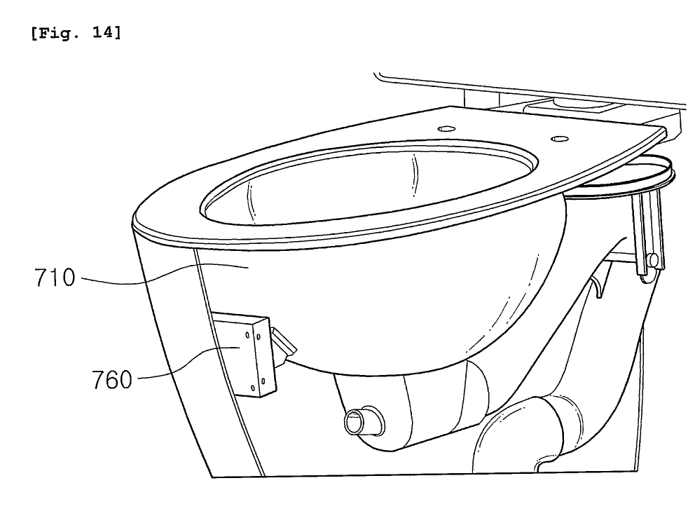

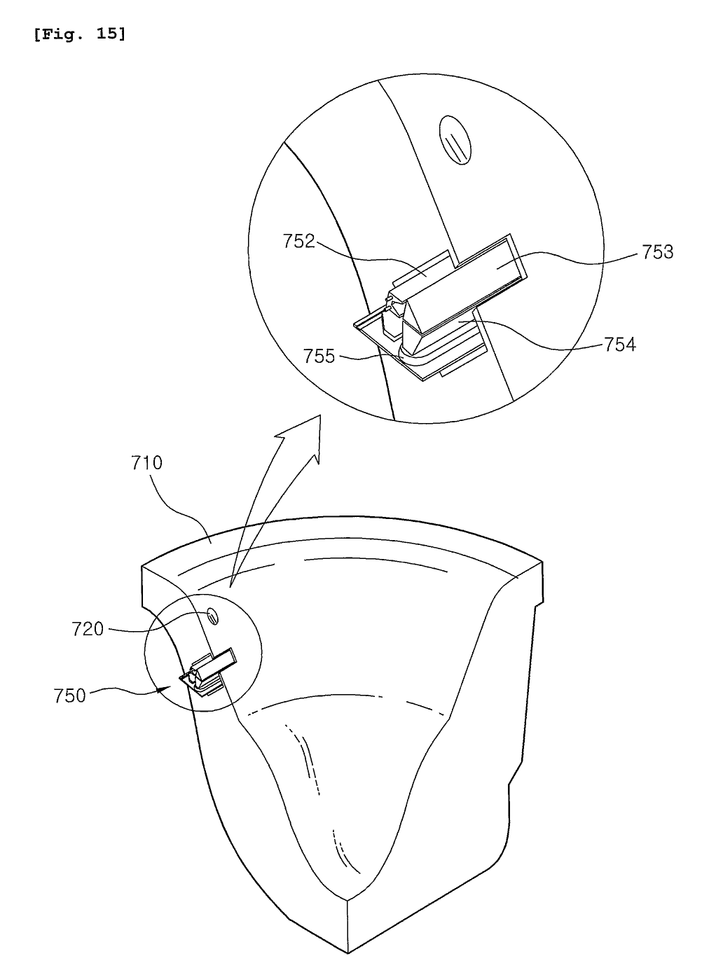

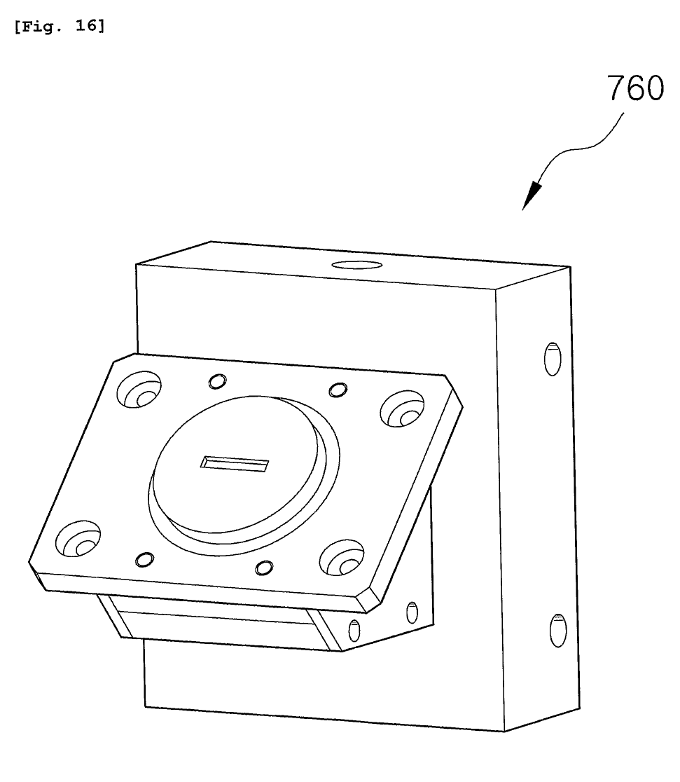

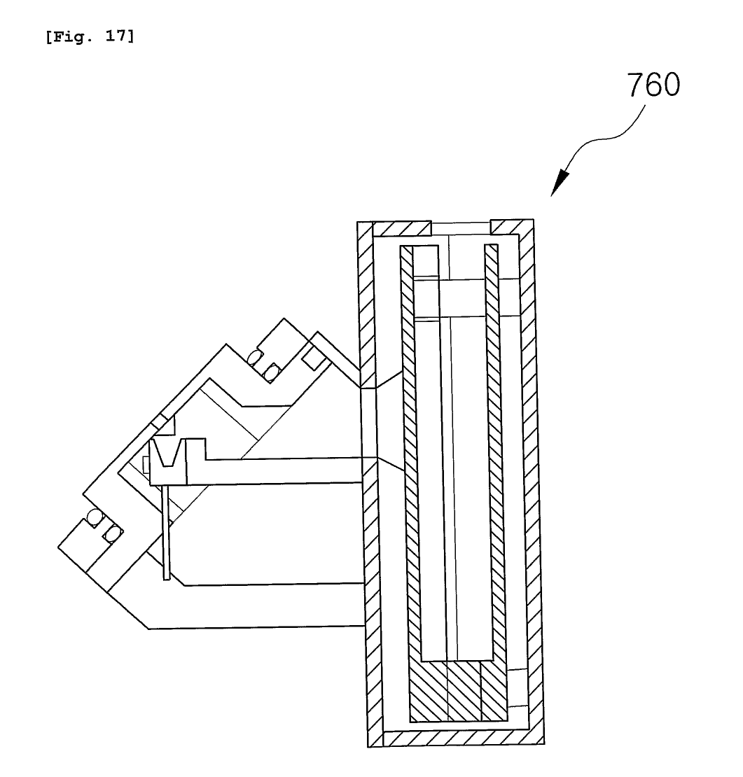

FIG. 16 is an external perspective view showing the spectroscopy module 760 which is applied to the analyzing apparatus 750 according to still another embodiment of the present invention, and FIG. 15 is a side cross-sectional vies of the spectroscopy module 760 of FIG. 16.

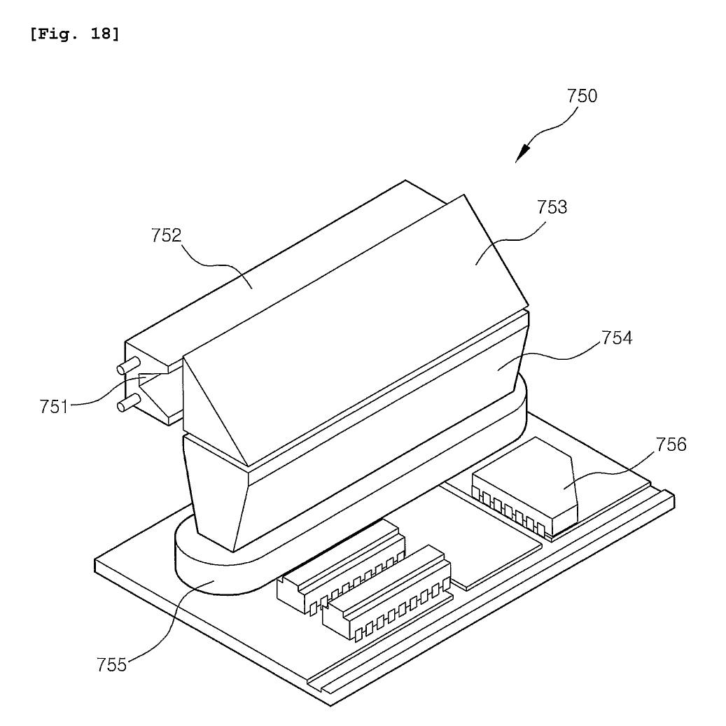

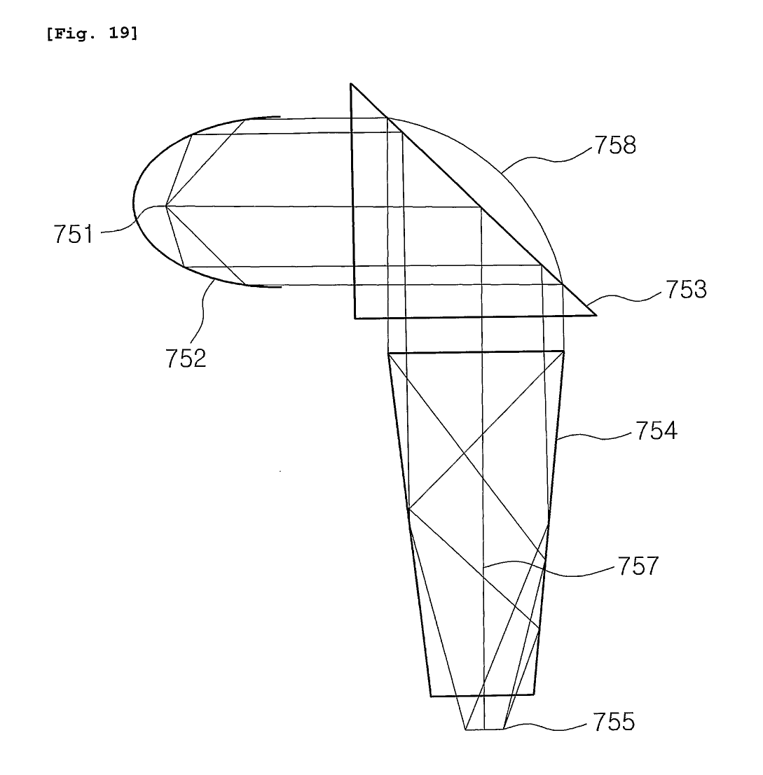

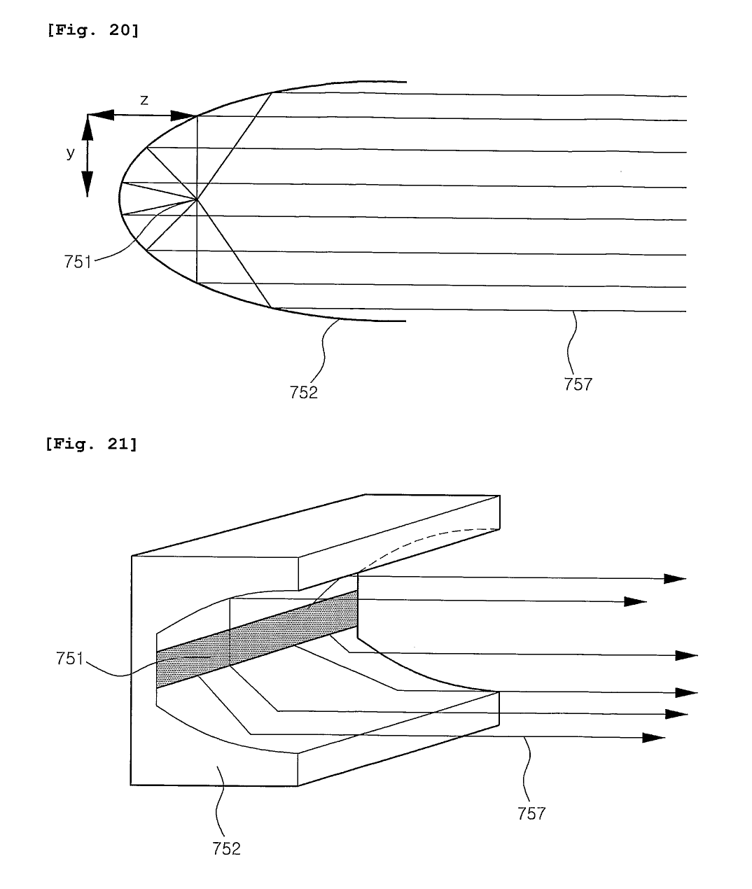

FIG. 20 is a drawing showing a principle of the reflecting mirror 752 shown in FIG. 18 and FIG. 19, and FIG. 13 is a perspective view of the reflecting mirror 752 according to an embodiment of the present invention. Referring to FIG. 20 and FIG. 21, the light generated by the light source unit 751 is reflected on the reflecting mirror 752 of parabolic shape and incident into the ATR prism 753. The reflecting mirror 752 of parabolic shape is calculated using an equation 1 below.

$$Sag ( z ) = \frac{{cy}^{2}}{1 + \sqrt{1 - ( 1 + k ) {c}^{2} {y}^{2}}} \qquad [ Equation 1 ]$$

wherein c is a curvature (=1/r (radius of curvature)), k is conic constant, and y is a height in an optical axis.

The reflecting mirror 752 is of cylinder-shape having r value of 2 mm, k value of −1, and maximum external diameter of 4 mm. That is, it has a parabolic shape in direction of y axis and an elongate shape (14 mm) in a direction of x axis. The light reflected by the reflecting mirror 752 is introduced into the prism 753. Since the cross-sectional shapes of the light source unit 751, the prism 753 and the receiving of the detector 755 are structured similarly to one another, it is possible to prevent a loss of the light source and thus increase efficiency.

FIG. 22 and FIG. 23 are drawings showing conditions which cause the light to be reflected totally at the prism 753. As mentioned earlier, the light 757 incident into the prism 753 has wavelength of one portion absorbed into the sample 758 at a slanted plane of the prism 753 and remaining reflected totally. In FIG. 22, the light incident into the slanted plane with a degree of i conforms to Snell's law according to an equation 2 below.

n sin i=n′ sin i′ [Equation 2]

wherein, n is a refractive index (3.43) of the medium and n is a refractive index (1) of the air. In order to cause the light to be reflected totally within the prism 753, i′ needs to be lower than 90 degree (in this case, sin i′=1) which is vertical to the normal line of the slanted plane of the prism 753, and at this time i is calculated according to an equation 3 below.

i=sin⁻¹(n′/n) [Equation 3]

Even though the value of i calculated via an experiment is about 17 degree, the present invention is not limited to it. Therefore, if i is greater than 17 degree, the light is totally reflected on the slanted plane of the prism 753. According to the present invention, since the light is incident with i of about 45 degree, most light is totally reflected on the slanted plane of the prism 753. The shape of the prism 753 is of a triangular shape having a length in x-axis direction of 14 mm and a cut-away surface of equilateral triangle. The light reflected totally on the prism 753 is introduced into the detector 755 via the light inductor 754.

FIG. 23 is a drawing illustrating a principle that the light is delivered via the light inductor 754. The light inductor 754 is a glass block having 6 polished surfaces which are slightly slanted and narrowed downwardly. As shown in FIG. 23, the light incident into the light inductor 754 is totally reflected in the inside of it and delivered, and at this time, it also conforms to the Snell's law. Therefore, when the inclination of the slanted surface of the light inductor 754 is steep, the total reflection condition is broken so that the light ray may be emitted out of the light inductor 754, and therefore the inclination of the slanted surface needs to be adjusted properly.

It is possible to use a mirror tunnel 759 instead of the light inductor 754. Even in a case of using the minor tunnel 759, if a degree of inclination is large, the light may be reflected on the inside of the mirror tunnel 759 and turned back, and therefore the inclination of the slanted surface needs to be adjusted properly. The light is totally reflected on the light inductor 754, whereas the light is reflected 90% on the mirror tunnel 759, which results in reducing the amount of the light by about 10% whenever reflection occurs.

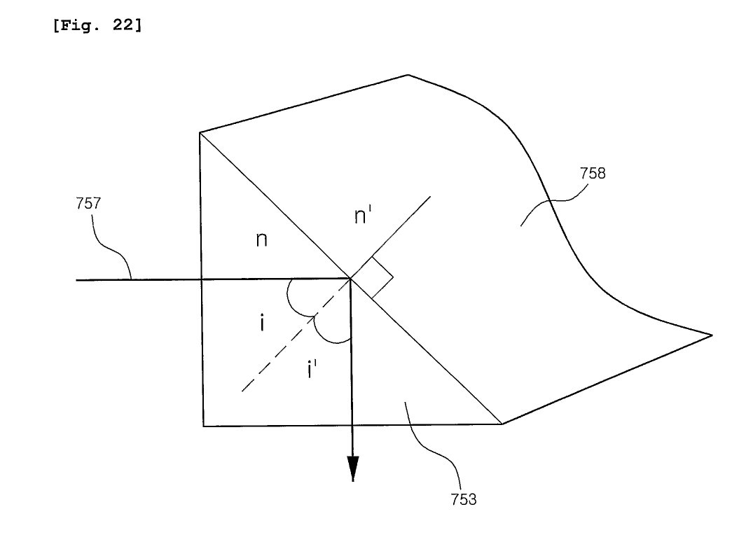

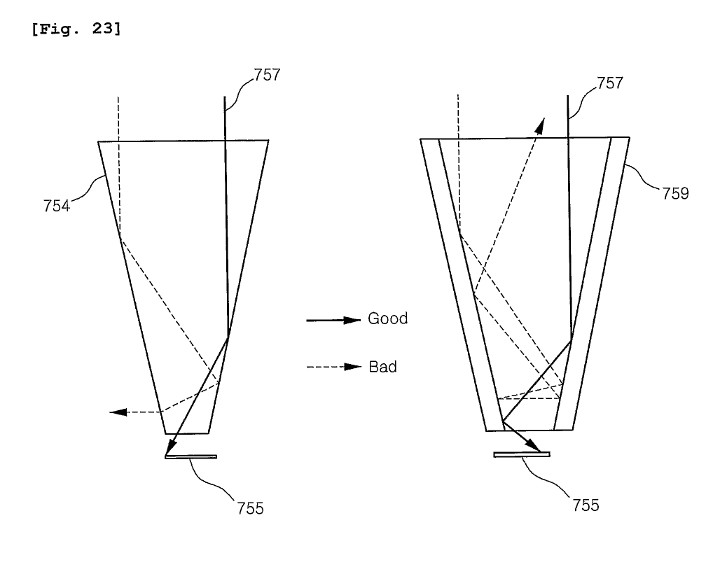

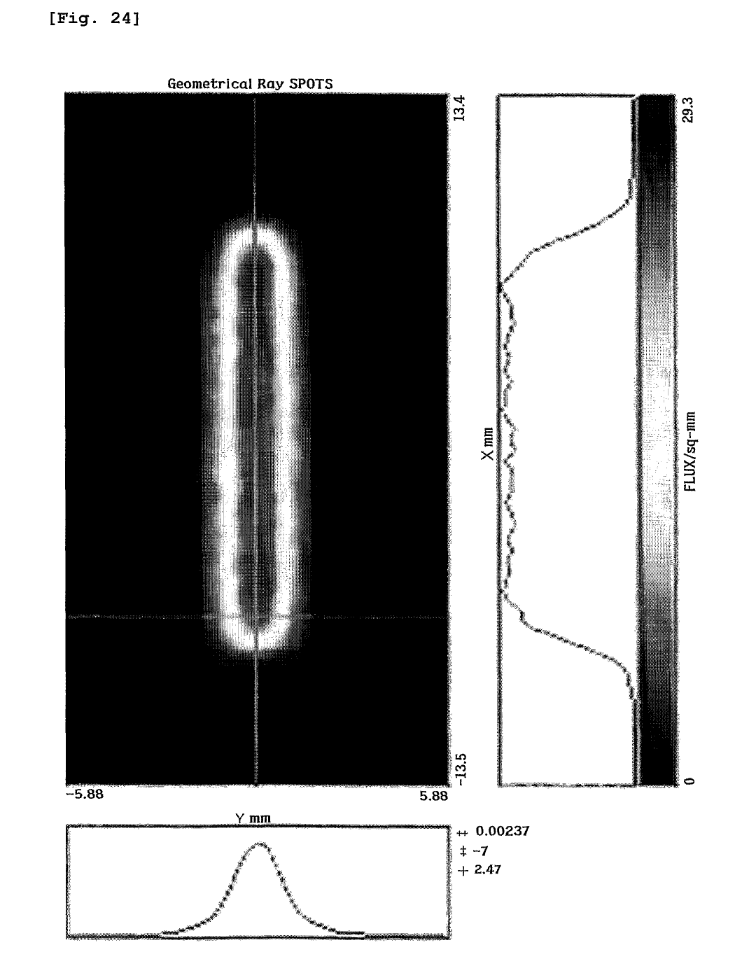

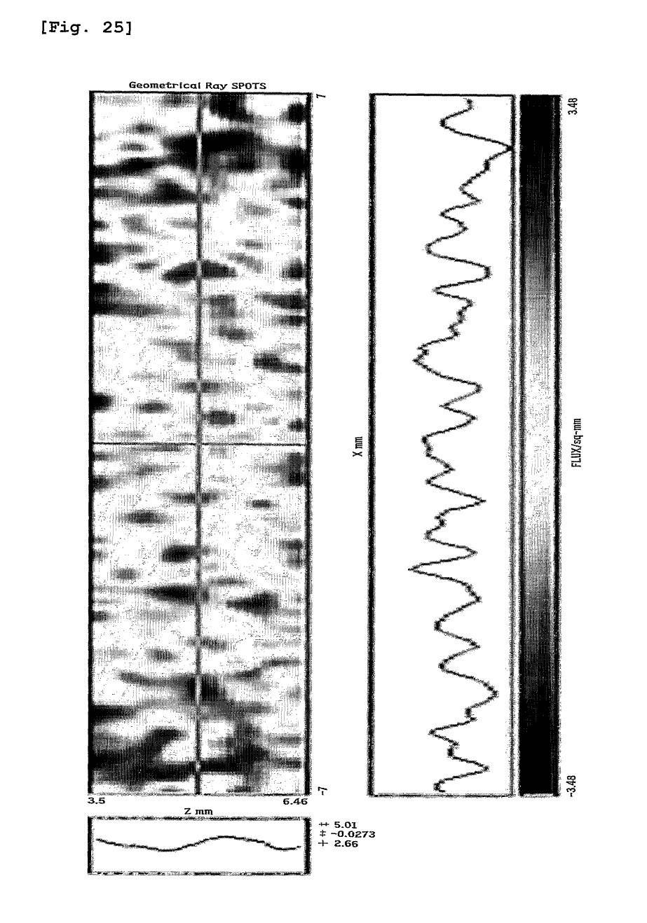

FIG. 24 is a graph showing the intensity of the light generated by the light source and FIG. 25 is a graph showing the intensity of the light measured by the detector 755 if the distance between the light source unit 751 and the detector 755 is 1 mm. Referring to FIG. 24, the light generated by the light source unit 751 and passing through the reflecting mirror 752 is equally measured. However, since the intensity of the light is dramatically reduced if the distance is greater than 5 mm, the distance between the light source unit 751 and the ATR is made lower than 5 mm to allow maximum light to be introduced into the ATR. More preferably, the distance may be selected in a range of 0.5 to 3 mm considering the organic characteristic. Consequently, it is possible to miniaturize the mid-infrared spectroscopy apparatus which is capable of being mounted on small space such as the toilet 710.

FIG. 25 shows the intensity of the light measured by the detector 755 when using the mirror tunnel 759 of diamond shape (13×3×27 mm) to deliver the light emitted from the ATR into the detector 755 efficiently.

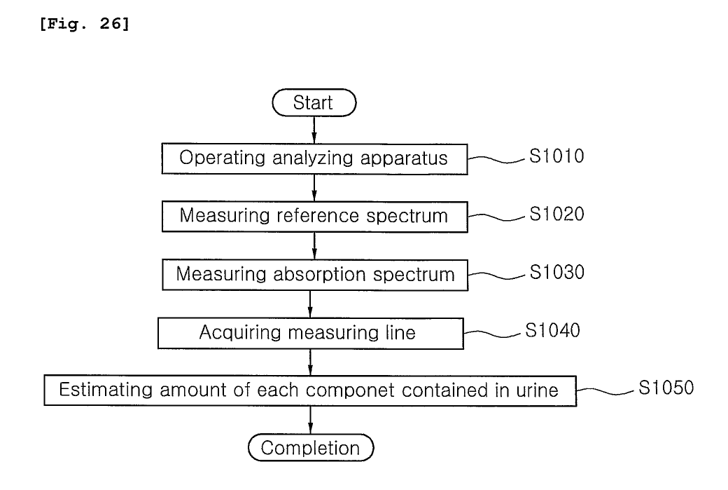

FIG. 26 is a flow diagram showing a method for analyzing the urine components using the urine component analyzing apparatus 700. Referring FIG. 26, it operates the analyzing system including the analyzing unit 750 of the urine component measuring apparatus 700 according to the present invention S1010. Then, the reference material is introduced into the analyzing unit 750 and the analyzing unit 750 measures a reference spectrum S1020. The reference material contains water.

Then, the sample is directly introduced into the ATR via a urine collector within the toilet stool 710. Then, the analyzing unit 750 including the ATR and the complex filter 761 measures the absorption spectrum using the sample introduced S1030. The absorption spectrum represents a certain wavenumber absorbed than the reference material as compared with the reference spectrum and the computation equation is calculated by log (reference spectrum/sample spectrum).

Then, it acquires a measuring line representing a correlation between the absorption spectrum and a standard value obtained by measuring each component of the sample S1040. It is possible to estimate the value of each component contained in the sample by substituting the absorption spectrum of the sample for the measuring line S1050. Generally, the measuring line has been already saved in the computer by confirming the correlation using the standard urine component and virtual value and then confirming R̂2 and SEC which are statistical criterion for the correlation.

Such total procedures are referred to a routine analysis. An important thing in the routine analysis is a standard error of prediction (SEP), as a statistical index on what is the difference between the measuring value and the virtual value, which may be obtained simultaneously with measuring.

In other words, the measuring line represents the correlation between the general absorption spectrum and the standard value obtained by measuring each component, e.g., Glucose, Albumin Nitrite and Bilirubin, of the sample, e.g., urine. One of the indexes representing an evaluation of the correlation is R̂2 and the other is a standard error of calibration (SEC) and Standard error of prediction (SEP). When the standard value and the spectrum value are represented by any straight line, R̂2, SEC and SEP represent the correlation between the standard value and the absorption spectrum according to how the data of two data is close to the certain straight line.

When it is most ideal, i.e., when the correlation between the standard value and the absorption spectrum is most good, R̂2 is 1 and SEC and SEP are close to 0 statistically. The relation between the standard value and the absorption spectrum may be represented using Multiple linear regression (MLR) and Regression of Partial Least Square (PLSR).

It measures a value of component contained in the sample, e.g., a value of Glucose using the measuring line. The value of component is expressed by a root mean of standard error prediction (RMSEP) value of reliability significance. The value of each component contained in the sample may be measured by measuring the component value within the reliability significance.

FIG. 27 is a graph showing spectrum results obtained by measuring Glucose in the urine using the urine component analyzing apparatus 700. FIG. 27 shows the measuring spectrum for Glucose having a concentration of 20%, 10%, 5% and 0.2%. After measuring water of a reference material at first, the absorption spectrum of Glucose for the reference material is expressed. The intensity of the spectrum is expressed as Absorbance unit (AU) of an absorptivity in a Y axis. The absorption spectrum measured by ATR-IR is expressed at about 0.01AU, and Glucose absorption spectrum may be confirmed between 900 and 1400 wavenumber of 4000 to 900 wavenumber which is measurement wavenumber region. As the concentration of Glucose is reduced by 0.2% for each stage starting from 20%, the absorption spectrum is reduced.

FIG. 28 is a graph showing spectrum results obtained by measuring Creatine in the urine using the urine component analyzing apparatus 700. FIG. 28 shows the measuring spectrum for Creatine having a concentration of 5%, 2% and 1%. The measuring spectrum is also an absorption spectrum which measures Creatine by using water as a reference material. The absorption spectrum measured by ATR-IR is expressed at about 0.008AU, and Creatine absorption spectrum may be confirmed between 1400 and 1900 wavenumber of 4000 to 900 wavenumber which is measurement wavenumber region. As the concentration of Glucose is reduced by 1% for each stage starting from 5%, the absorption spectrum is reduced.

FIG. 29 is a graph showing spectrum results obtained by measuring Urea in the urine using the urine component analyzing apparatus 700. FIG. 29 shows the measuring spectrum for Urea having a concentration of 10%, 5%, and 2%. The measuring spectrum is also an absorption spectrum which measures Urea by using water as a reference material. The absorption spectrum measured by ATR-IR is expressed at about 0.012AU, and Urea absorption spectrum may be confirmed between 1400 and 1900 wavenumber of 4000 to 900 wavenumber which is measurement wavenumber region. As the concentration of Glucose is reduced by 2% for each stage starting from 10%, the absorption spectrum is reduced.

FIG. 30 is a graph showing spectrum results obtained by measuring Cholesterol in the urine using the urine component analyzing apparatus 700.

FIG. 30 shows the measuring spectrum for Cholesterol having a concentration of 2%, 1% and 0.5%. The measuring spectrum is an absorption spectrum which measures Cholesterol by using chloroform CHCl3 as a reference material. The absorption spectrum measured by ATR-IR is expressed at about 0.005AU, and Cholesterol absorption spectrum may be confirmed between 2700 and 3100 wavenumber of 4000 to 900 wavenumber which is measurement wavenumber region. As the concentration of Glucose is reduced by 0.5% for each stage starting from 2%, the absorption spectrum is reduced.

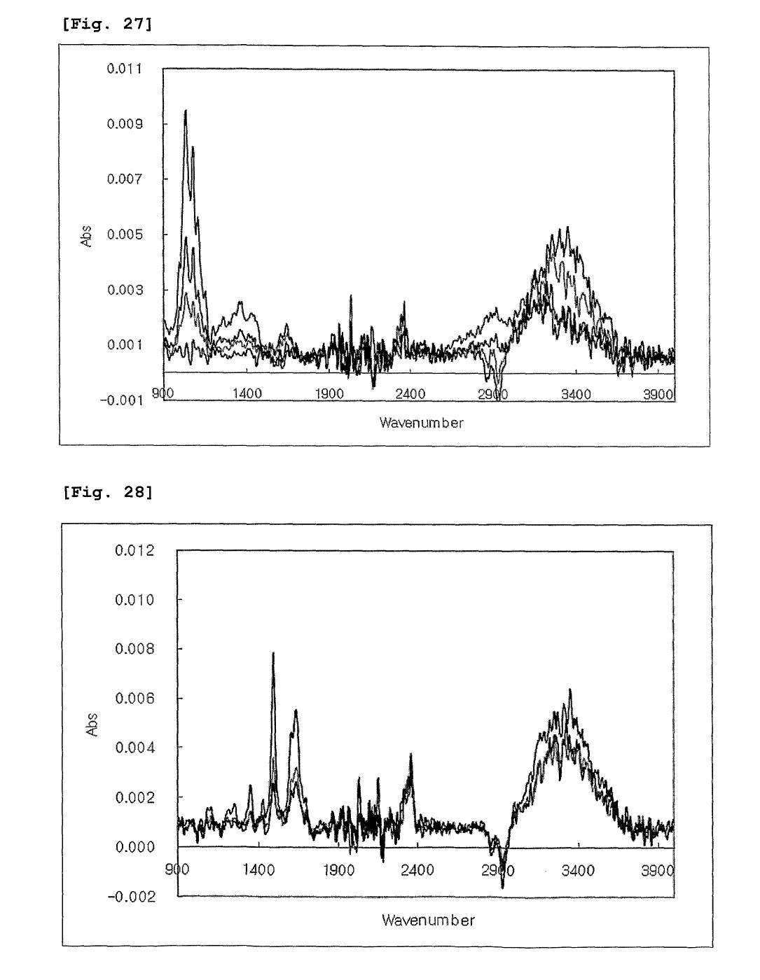

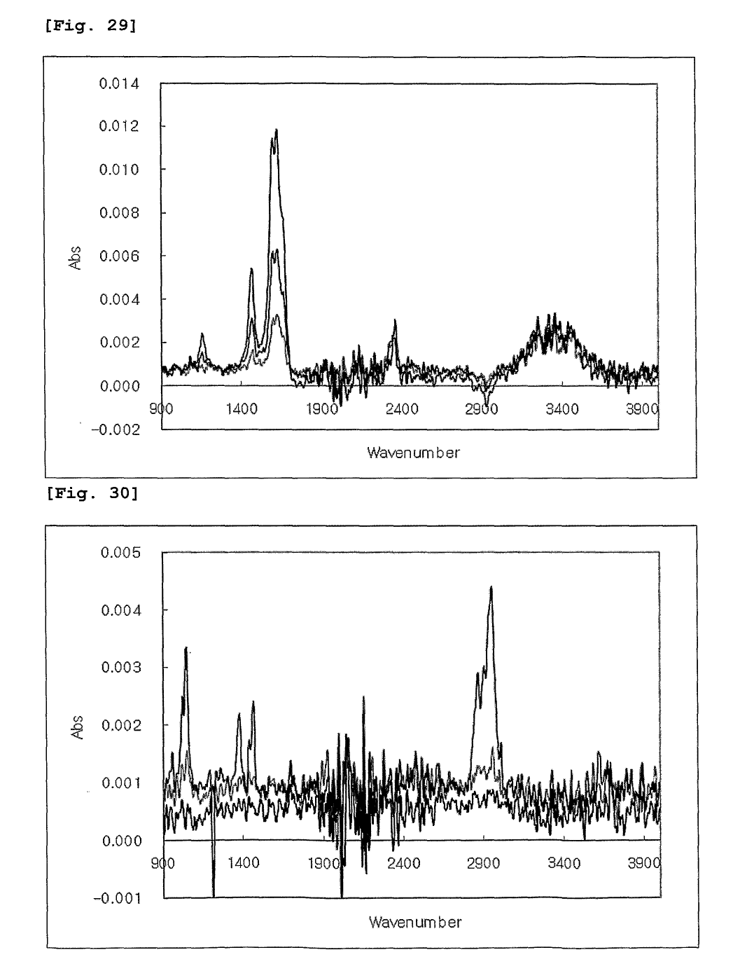

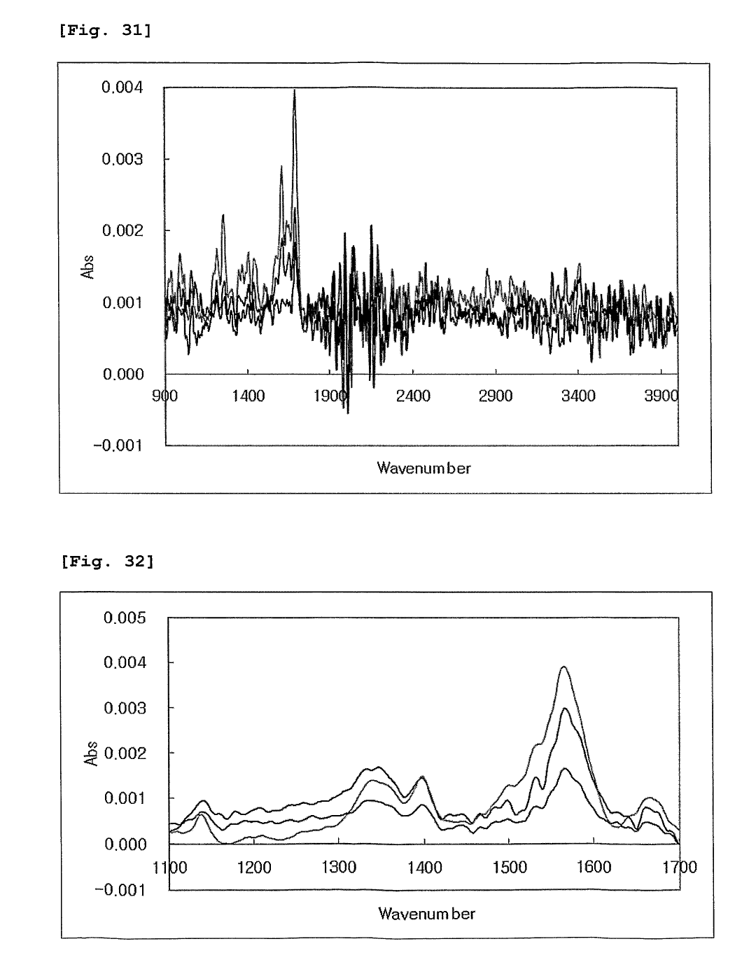

FIG. 31 is a graph showing spectrum results obtained by measuring Bilirubin in the urine using the urine component analyzing apparatus 700.

FIG. 31 shows the measuring spectrum for Bilirubin having a concentration of 2%, 1% and 0.5%. The measuring spectrum is an absorption spectrum which measures Bilirubin by using chloroform (CHCl3) as a reference material similarly to FIG. 30. The absorption spectrum measured by ATR-IR is expressed at about 0.004AU, and Bilirubin absorption spectrum may be confirmed between 1300 and 1800 wavenumber of 4000 to 900 wavenumber which is measurement wavenumber region. As the concentration of Bilirubin is reduced by 0.5% for each stage starting from 2%, the absorption spectrum is reduced.

FIG. 32 is a graph showing spectrum results obtained by measuring Uric acid in the urine using the urine component analyzing apparatus 700. FIG. 32 shows the measuring spectrum for Uric acid having a concentration of 2%, 1% and 0.5%. The measuring spectrum is also an absorption spectrum which measures Uric acid by using water and sodium hydroxide (NaOH) as a reference material. The absorption spectrum measured by ATR-IR is expressed at about 0.005AU, and Uric acid absorption spectrum may be confirmed between 1100 to 1700 wavenumber which is measurement wavenumber region. As the concentration of Uric acid is reduced by 0.5% for each stage starting from 2%, the absorption spectrum is reduced.

FIG. 33 is a graph showing spectrum results obtained by measuring Nitrite in the urine using the urine component analyzing apparatus 700. FIG. 33 shows the measuring spectrum for Nitrite having a concentration of 2%, 1% and 0.5%. The measuring spectrum is also an absorption spectrum which measures Nitrite by using water as a reference material. The absorption spectrum measured by ATR-IR is expressed at about 0.002AU and derived between 1,100 to 1,500 wavenumber which is a measurement wavenumber region. As the concentration of Nitrite is reduced by 0.5% for each stage starting from 2%, the absorption spectrum is reduced.

FIG. 34 is a graph showing a measuring line of Glucose in the urine using the urine component analyzing apparatus 700. As shown in FIG. 34, considering correlation between the standard concentration value and varied absorption spectrums of Glucose for each concentration of 20%, 10%, 5% and 0.2%, since the correlation to the absorption spectrum is represented as a straight line with R̂2 of 0.999, the amount of Glucose may be estimated via the absorption spectrum.

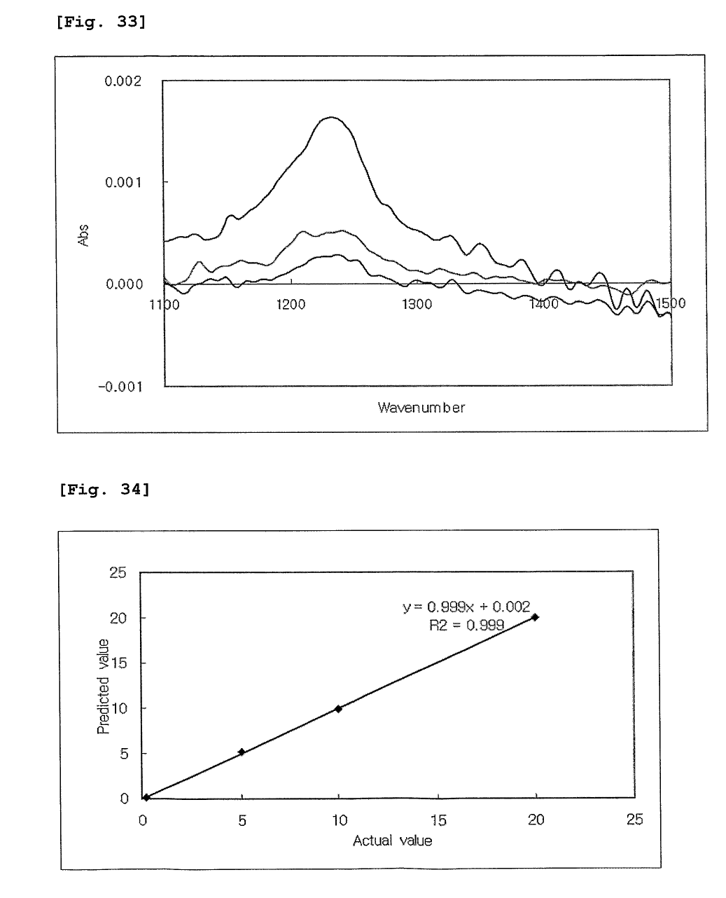

FIG. 35 is a graph showing a measuring line of Creatine in the urine using the urine component analyzing apparatus 700. As shown in FIG. 35, considering correlation between the standard concentration value and varied absorption spectrums of Creatine for each concentration of 5%, 2% and 1%, since the correlation to the absorption spectrum is represented as a straight line with R̂2 of 0.997, the amount of Creatine may be estimated via the absorption spectrum.

FIG. 36 is a resulting graph showing a measuring line of Urea in the urine using the urine component analyzing apparatus 700. As shown in FIG. 36, considering correlation between the standard concentration value and varied absorption spectrums of Urea for each concentration of 10%, 5% and 2%, since the correlation to the absorption spectrum is represented as a straight line with R̂2 of 0.987, the amount of Urea may be estimated via the absorption spectrum.

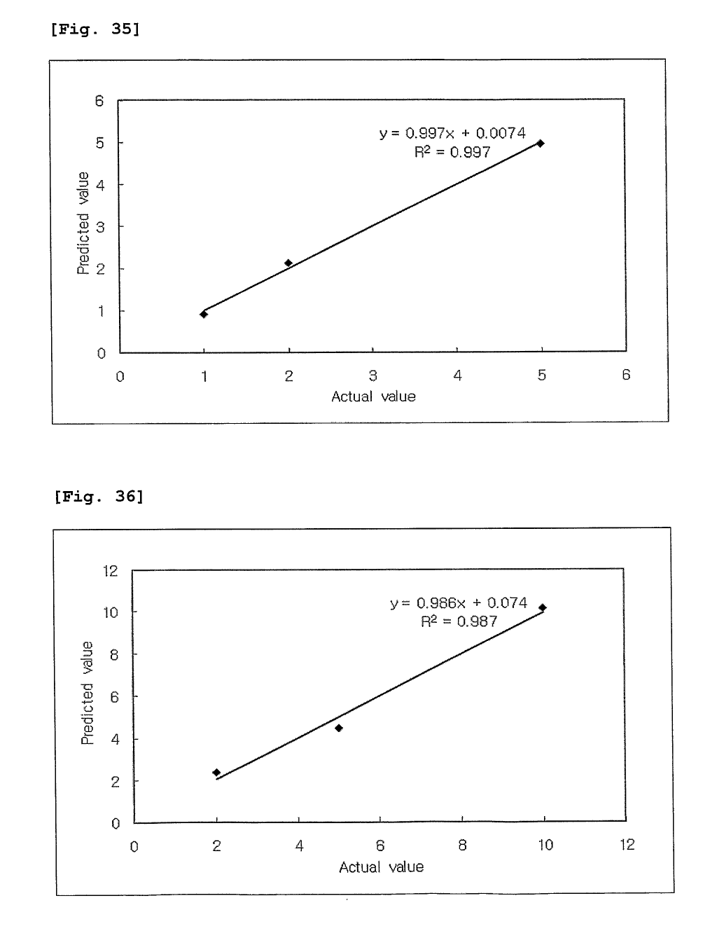

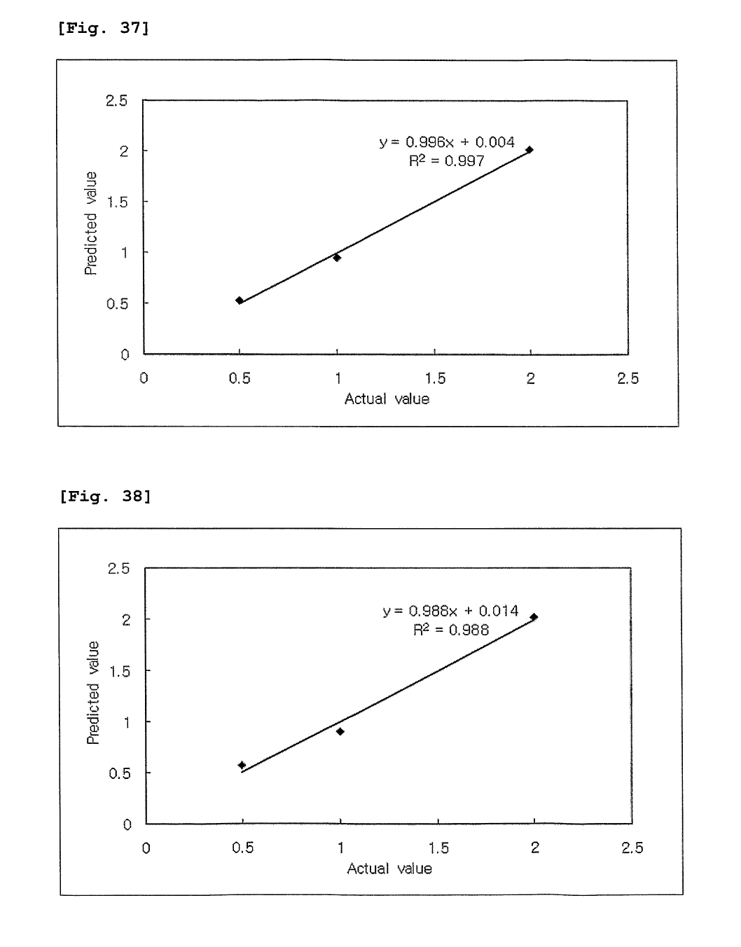

FIG. 37 is a resulting graph showing a measuring line of Cholesterol in the urine using the urine component analyzing apparatus 700. As shown in FIG. 37, considering correlation between the standard concentration value and varied absorption spectrums of Cholesterol for each concentration of 2%, 1% and 0.5%, since the correlation to the absorption spectrum is represented as a straight line with R̂2 of 0.997, the amount of Cholesterol may be estimated via the absorption spectrum.

FIG. 38 is a resulting graph showing a measuring line of Bilirubin in the urine using the urine component analyzing apparatus 700 according to one embodiment of the present invention. As shown in FIG. 38, considering correlation between the standard concentration value and varied absorption spectrums of Bilirubin for each concentration of 2%, 1% and 0.5%, since the correlation to the absorption spectrum is represented as a straight line with R̂2 of 0.998, the amount of Bilirubin may be measured via the absorption spectrum.

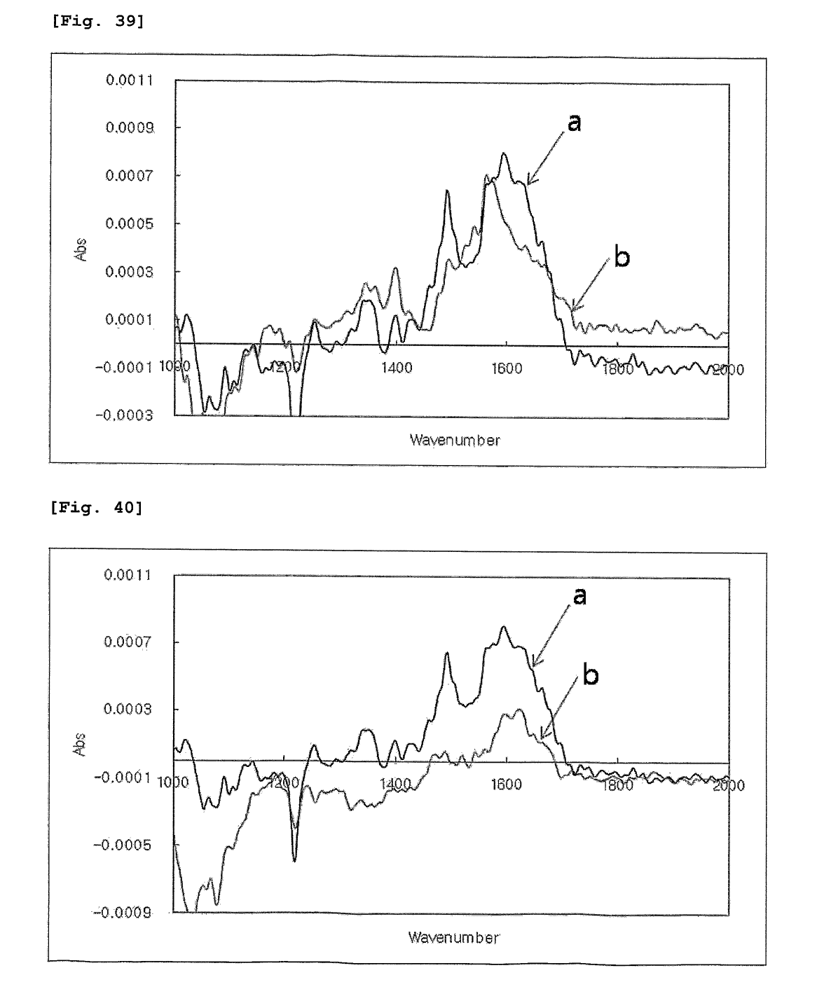

FIG. 39 is an absorption spectrum for measuring Uric acid contained in the urine sample using the urine component analyzing apparatus 700 according to one embodiment of the present invention. As shown, a case of a) is to measure the absorption spectrum of Uric acid in the sample after measuring whole sample using water as a reference. It is not possible to remove the Uric acid absorption spectrum when it has the same concentration as the sample component such as Creatine. Meanwhile, a case of b) is to measure the absorption spectrum by using the urine except for the Uric acid as the reference material in order to remove the separate absorption spectrum of Uric acid. In the case, it may be ascertained that the absorption spectrum of such as Creatine is excluded and the Uric acid spectrum is expressed.

FIG. 40 is an absorption spectrum for measuring Urea contained in the urine sample by using the urine component analyzing apparatus 700 according to one embodiment of the present invention. As shown, a case of A) is to measure the absorption spectrum of Urea in the sample after measuring whole sample using water as a reference. It is not possible to remove the Urea spectrum when it has the same concentration as the sample component such Creatine. However, a case of B) is to measure the absorption spectrum by using the urine except for the Uric acid as the reference material in order to remove the separate absorption spectrum of Uric acid. In the case, it may be ascertained that the absorption spectrum of such as Creatine is excluded and the Urea spectrum is expressed.

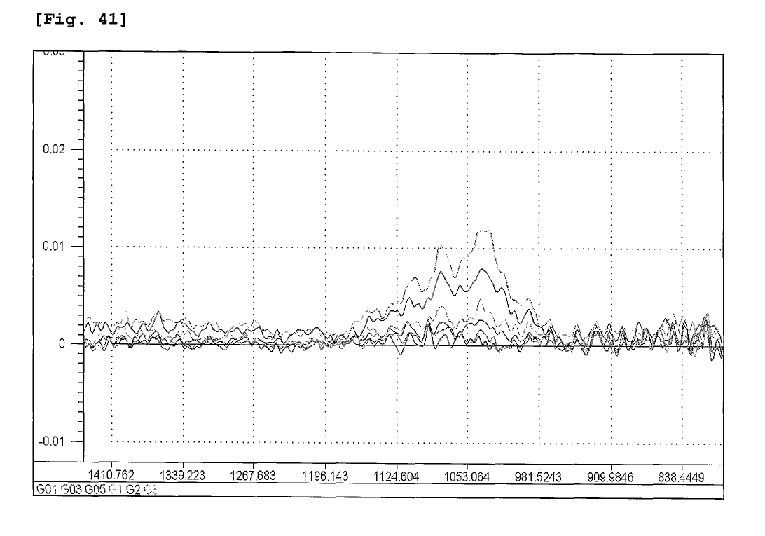

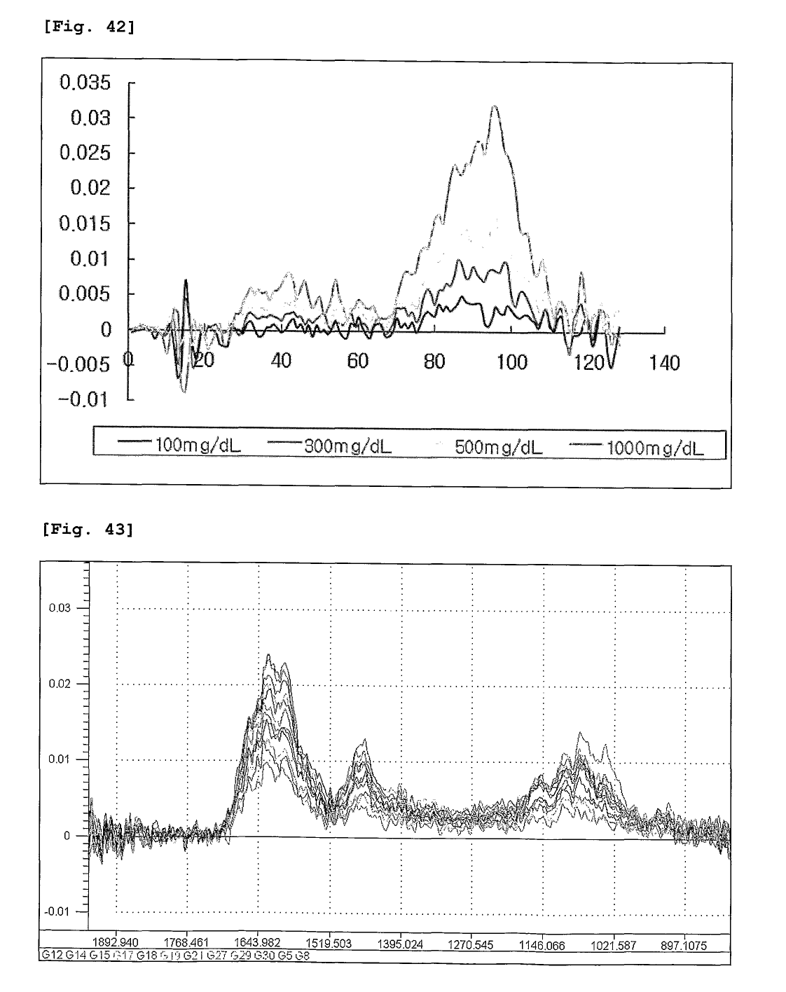

FIG. 41 is a spectrum for standard Glucose sample measured using prior FT-IR and FIG. 42 is a spectrum for standard Glucose sample measured using the urine analyzing apparatus 700. The Glucose standard sample is melted into the third distilled water to prepare 100 mg/dL, 300 mg/dL, 500 mg/dL, 1000 mg/dL, before finding the spectrum. As shown in FIG. 41 and FIG. 42, it will be appreciated that the spectrums of the standard Glucose sample using the prior FT-IR and the urine component analyzing apparatus 700 according to the present invention have a Glucose peak appeared at 950˜1150 cm−1 without a large difference between them.

Generally, since the prior IR equipment has the light source of low sensitivity, the measurement is performed using prior FT method. The prior FT method needs to deal with the data using Fourier transformation after dividing the ray of light source into two rays and making interference fringes by changing a length of a light path in one light ray periodically. At this time, since He—Ne laser needs to be used for making uniform the velocity of the moving mirror and making certain the position of the moving mirror to obtain reliable interference, it is very complex and big-sized so that it may not be attached on the toilet 710. Meanwhile, the urine component analyzing apparatus 700 according to the present invention can exhibit the same effect as the prior art as shown in FIG. 41 and FIG. 42, even though it is manufactured with low cost and small size.

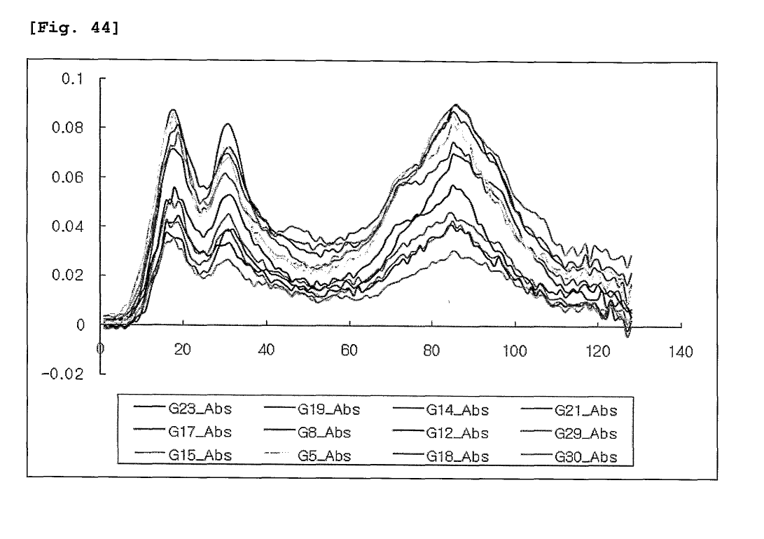

FIG. 43 is a spectrum which measures a urine sample taken from glycosuria patient using the prior FT-IR, and FIG. 44 is a spectrum which measures the urine sample using the urine component analyzing apparatus 700 according to an embodiment of the present invention. As shown in FIG. 43 and FIG. 44, a peak of protein is expressed at near 1600 cm−1 but a peak of Glucose is not overlapped, in the urine sample taken form the glycosuria patient. However, a basis line is slightly raised due to other different materials existing in the urine.

Those skilled in the art will appreciate that the conceptions and specific embodiments disclosed in the foregoing description may be readily utilized as a basis for modifying or designing another embodiments for carrying out the same purposes of the present invention. Those skilled in the art will also appreciate that such equivalent embodiments do not depart from the spirit and scope of the invention as set forth in the appended claims.

1. An apparatus for analyzing urine components in a toilet, comprising:
a toilet stool 710;
a urine-collector (not shown) formed on a whole surface inside the toilet stool in a concave shape or a flat shape;
an analyzing unit 750 attached on the toilet stool 710 to analyze components of the urine collected from the urine-collector and including one or more of a light source unit 751, a complex filter 761, a reflecting mirror 752, and a detector 755; and
an attenuation prism 753 (ATR prism) provided within the analyzing unit 750 for analyzing the urine components,
wherein the light source unit 751 and a light-receiving unit 762 of the detector 755 have cross-sectional shape vertical to a light path corresponding similarly to each other in order to minimize a loss of the light and maintain high signal-to-noise ratio (SN ratio).

2. The apparatus for analyzing urine components in a toilet as set forth in claim 1, wherein the light source unit 751 uses a mid-infrared having wavelength in a range of 2,500 to 15,000 nm.

3. The apparatus for analyzing urine components in a toilet as set forth in claim 2, wherein the prism 753 has a cross-sectional surface of a transmitting portion vertical to the light path corresponding similarly to a cross-sectional surface of the light source unit 751 or the light-receiving unit 762 of the detector 755.

4. The apparatus for analyzing urine components in a toilet as set forth in claim 2, wherein a total trace distance of the light from the light source unit 751 to the detector 755 is 10 to 50 mm.

5. The apparatus for analyzing urine components in a toilet as set forth in claim 4, wherein a distance between the light source unit 751 and the prism 753 is 300 μm to 5 mm.

6. The apparatus for analyzing urine components in a toilet as set forth in claim 4, wherein a distance between the prism 753 and the detector 755 is 300 μm to 5 mm.

7. The apparatus for analyzing urine components in a toilet as set forth in claim 2, wherein the light source unit 751 has an array structure in which a plurality of small heaters are arranged in one array.

8. The apparatus for analyzing urine components in a toilet as set forth in claim 7, wherein the array structure of the light source unit 751 is formed of more than 2 layers to cause pulses of the light source from the light source unit 751 and the detector 755 to be synchronized to each other.

9. The apparatus for analyzing urine components in a toilet as set forth in claim 3, wherein the prism 753 has an incidence plane and an emission plane which are opposite to each other and form any prescribed degree.

10. The apparatus for analyzing urine components in a toilet as set forth in claim 3, wherein the analyzing unit 750 comprises a tapered rod or a mirror tunnel 759 to introduce the light passing through the prism 753 into the detector 755.

11. The apparatus for analyzing urine components in a toilet as set forth in claim 1, wherein the urine components comprise any one selected from a group consisted of Glucose, Creatine, Urea, Protein, Albumin, PH, Triglyceride, Cholesterol, Bilirubin, Uric acid and Nitrite.

12. The apparatus for analyzing urine components in a toilet as set forth in claim 1, wherein the analyzing apparatus 700 further comprises any one selected from a group consisted of a blood pressure measuring device, a body fat measuring device, and an electrocardiogram measuring device.

13. The apparatus for analyzing urine components in a toilet as set forth in claim 12, wherein the analyzing apparatus 700 is operated after a user is authenticated by a fingerprint recognition device 300.

14. A method for analyzing urine components in real-time, comprising:
measuring a spectrum of a reference material introduced via a urine-collecting unit of a toilet using an Attenuated Total Reflectance (ATR) of an analyzing unit 750;
measuring an absorption spectrum of the urine introduced via the urine-collecting unit using the ATR of the analyzing unit 750;
acquiring a measuring line which represents the correlation between the absorption spectrum and a standard value measuring each component of the urine in advance; and
estimating an amount of each component contained in the urine using the measuring line,
wherein the light source unit 751 and a light-receiving unit 762 of the detector 755 have a cross-sectional surface vertical to a light path corresponding similarly to each other, in order to maintain high SN ratio.

15. The method for real-time analyzing urine components as set forth in claim 14, wherein the spectrum of the reference material and the absorption spectrum of the urine are measured using the light introduced into the ATR.

16. The method for real-time analyzing urine components as set forth in claim 15, wherein the light is a mid-infrared having a wavelength in a range of 2,500 to 15,000 nm.

17. The method for real-time analyzing urine components as set forth in claim 14, wherein the prism 753 has a cross-sectional surface of a transmitting portion vertical to the light path corresponding similarly to a cross-sectional surface of the light source unit 751 or the light-receiving unit 762 of the detector 755.

18. The method for real-time analyzing urine components as set forth in claim 14, wherein the reference material is water, air or a combination thereof according to the urine components to be measured.

19. The method for real-time analyzing urine components as set forth in claim 14, wherein the urine components comprise any one selected from a group consisting of Glucose, Creatine, Urea, Protein, Albumin, PH, Triglyceride, Cholesterol, Bilirubin, Uric acid and Nitrite.
